(19) United States
(12) Patent Application Publication
(10) Pub. No.: US 2011/0222038 A1
(43) Pub. Date: Sep. 15, 2011

(54) SUBSTRATE PROCESSING APPARATUS AND SUBSTRATE PLACING TABLE

(75) Inventor: Jun Yamashita, Hyogo-Ken (JP)

(73) Assignee: TOKYO ELECTRON LIMITED, Tokyo-To (JP)

(21) Appl. No.: 13/119,141

(22) PCT Filed: Sep. 16, 2009
(86) PCT No.: PCT/JP2009/066160

§ 371 Date: May 27, 2011

(30) Foreign Application Priority Data
Sep. 16, 2008 (JP) 2008-236949
Sep. 16, 2008 (JP) 2008-236950
Sep. 16, 2008 (JP) 2008-236951

(51) Int. Cl. G03B 27/58

(52) U.S. Cl. 355/53; 355/72

(57) ABSTRACT

A substrate processing apparatus, for performing a plasma process to a substrate (W) in a processing container held in a vacuum state, has a substrate placing table (5) for placing thereon the substrate (W) in the processing container. The substrate placing table (5) includes: a substrate placing table body (51) composed of AlN; a heat generation member (56) disposed in the substrate placing table body (51) for heating the substrate; a first cover (54), made of quartz, covering a surface of the substrate placing table body (51); a plurality of lift pins (52) for moving the substrate (W) up and down; a plurality of insertion holes (53) through which the lift pins (52) are inserted in the substrate placing table body (51); a plurality of openings (54a) formed in the first cover, located at positions corresponding to the plurality of insertion holes (53), respectively; and second covers (55) made of quartz which are formed separately from the first covers, and each of which covers at least a portion of an inner surface of the opening (54a) and at least a portion of an inner circumferential surface of the insertion hole (53).

### TECHNICAL FIELD

The present invention relates to a substrate processing apparatus for applying a predetermined process such as plasma processing to a substrate, for example, a semiconductor wafer, and relates to a substrate placing table for placing a substrate thereon in a processing container of the substrate processing apparatus.

### BACKGROUND ART

In the manufacture of a semiconductor device, plasma processing is performed as follows. A semiconductor wafer which is a substrate to be processed (hereinafter simply referred to as a wafer) is placed on a wafer placing table in a processing container, a plasma is generated in the processing container, and then the wafer is subjected to oxidation treatment, nitridation treatment, film deposition, etching, etc. with the wafer heated by a heater disposed in a placing table body.

Parallel plate type apparatus has been often used as the plasma apparatus for performing the plasma processing described above. As a plasma processing apparatus capable of forming a plasma having a higher density and a lower electron temperature, an RLSA (Radial Line Slot Antenna) microwave plasma processing apparatus, which generates a plasma by introducing microwaves into a processing container via a plane antenna having a plurality of slots (refer, for example, to Japanese Patent Laid-Open No. 2000-294550), attracts attention recently.

In the plasma processing, when the wafer placing table is exposed to a plasma, the semiconductor wafer which is a substrate may possibly be contaminated by metal atoms contained in the plasma as contaminants.

As a technique of preventing such contamination, Japanese Patent Laid-Open Publication No. 2007-266595 discloses that a main body of a wafer placing table is covered with a cover made of quartz.

A wafer placing table employing AlN, an insulating ceramics having good thermal conductivity, for a placing table body, and having a heater embedded therein has been frequently used. Since a semiconductor wafer may be possibly contaminated with Al in AlN in such a wafer placing table, the cover made of quartz is particularly effective.

Since insertion holes for insertion of lift pins are formed in the wafer placing table for lifting the semiconductor wafer, AlN is exposed at the periphery of the insertion hole and in the insertion hole even when the placing table body is covered with a cover made of quartz. Even Al contamination from an AlN portion of such a small area may sometimes cause a problem. Recently, it has been demanded for further increasing the size of the semiconductor wafer and further refinement of the device, and a method of performing plasma processing by applying a high frequency power for bias to the wafer placing table has been attempted with a view point of enhancing the efficiency of the plasma processing, uniformity of the processing, etc. When such a method is used, the contamination level may possibly exceed the allowable range due to ion drawing effect even if the area for the AlN exposed portion is small.

As a method of preventing contamination, it may be considered as disclosed in Japanese Patent Laid-Open Publication No. 2007-235116 to provide a head having an enlarged diameter at the top end of the lift pin and close the AlN exposure portion of the insertion hole by the head. However, with such a method, while the exposed portion is narrowed, the exposed portion cannot be eliminated completely in view of positioning margin. Further, since the size for the insertion hole cannot be increased with a view point, for example, of uniform heating and, further, the size of the head is restricted in view of the accuracy, a floating pin has to be used actually as the lift pin (refer to the followings). In this case, since the positional accuracy for the lift pin itself is not sufficient, the lift pin and the placing table body rub to each other to generate particles.

Further, while it may be considered to completely eliminate the AlN exposed portion by forming a cover made of quartz as that having a cylindrical portion that covers the inside of the insertion hole integrally, the cylindrical portion may possibly be broken due to the thermal expansion difference between AlN and quartz.

Further, in the wafer placing table, a plurality of (typically three) lift pins are moved up and down by a lifting arm provided below the lift pins. For example, as disclosed in Japanese Patent Laid-Open Publication No. 2006-225763, the lift pin is screw fastened to the lifting arm. In another example, a lift pin is fitted into a hole formed in the lifting arm and the lift pin is fixed by a fastening screw from the side of the hole.

In a further example, as shown, for example, in Japanese Patent Laid-Open Publication No. 2004-343032, a lift pin is disposed elevatably so as not to come off from the insertion hole and the lift pin is not fixed to the lifting arm, in which the lift pin is pushed upward by the lifting arm when the lift pin is to be raised, and the lifting arm is moved downward to lower the lift pin by its own weight when the lift pin is to be lowered. Such a lift pin is referred to as a floating pin.

In the configuration disclosed in Japanese Patent Laid-Open Publication No. 2006-225763, since the lift pin is completely fixed to the lifting arm, the positional adjustment between the insertion hole of the wafer placing table and the lift pin must be performed by moving the pins together with the whole lifting arm and optimal positioning cannot be adjusted on every lift pin. Further, also in the technique of fixing the lift pin from the side by a fastening screw, optimal positional adjustment cannot be conducted on every lift pin and, in addition, the lift pin may be tilted and abutted against the inner surface of the insertion hole upon securing by a fastening screw to possibly generate particles.

In contrast, when the flowing pin as shown in Japanese Patent Laid-Open Publication No. 2004-343032 is used, positional adjustment for the lift pin is not necessary. However, the inner surface of the insertion hole and the lift pin are frictionally rub to each other which may possibly generate particles.

Further, with the provision of a cover formed of quartz such as disclosed in Japanese Patent Laid-Open Publication No. 2007-266595 described above, when a process under heating is performed, the temperature at the outer circumference of a wafer tends to be lowered. For example, in the silicon oxidation treatment processing which is performed while heating a wafer, for example, to about 400° C., the temperature tends to be lowered at the outer circumference of the wafer. In this case, the oxidation rate is lowered at the low temperature portion to worsen the uniformity of the oxidation treatment.

### SUMMARY OF THE INVENTION

The present invention provides a technique capable of decreasing contamination to substrates placed, without troubles such as destruction of the cover.

The present invention provides a technique capable of conducting accurate positioning between a plurality of insertion holes and a plurality of lift pins and capable of suppressing generation of particles due to rubbing of the lift pin and the inner surface of the insertion hole against one another.

The present invention provides a technique capable of performing uniform processing while preventing lowering of the temperature at the outer circumference of the process object.

The present invention provides a substrate placing table for placing a substrate thereon in a processing container in a substrate processing apparatus for performing plasma processing to the substrate in the processing container held in vacuum, the substrate placing table comprising: a substrate placing table body composed of AlN; a heat generation member disposed in the substrate placing table body to heat the substrate placed thereon; a first cover, made of quartz, covering a surface of the substrate placing table body; a plurality of lift pins provided so as to be projectable and retractable relative to an upper surface of the substrate placing table to move the substrate up and down; a plurality of insertion holes formed in the substrate placing table body to allow the lift pins to be inserted through; a plurality of openings formed in the first cover, located at positions corresponding to the plurality of insertion holes, respectively; and a plurality of second covers made of quartz, disposed at the insertion holes, respectively, and formed separately from the first cover, wherein each of the second covers at least a portion of an inner circumferential surface of the insertion hole corresponding to the second cover and at least a portion of an inner surface of the opening corresponding to the second cover, such that a surface, near an upper end of the corresponding to the insertion hole, of the substrate placing table body composed of AlN is not exposed to a plasma generated in the processing container.

In a preferred embodiment, each of the second covers has a cylindrical portion covering at least an upper portion of the inner circumferential surface of each of the insertion holes and a flanged portion extending outward from the upper end of the cylindrical portion, and the flanged portion is disposed in the opening. In this case, preferably, each of the insertion holes has, in an upper portion thereof, a large diameter hole portion of a larger diameter, and the cylindrical portion is fitted into the large diameter hole portion. The cylindrical portion may be configured so as to cover the entire inner circumferential surface of the insertion hole.

Further, in the preferred embodiment described above, preferably, a step is formed in the inner surface of each of the openings, whereby the opening has an upper small diameter portion and a lower large diameter portion and an eave protruding above the large diameter portion of the opening is disposed in the first cover; and the flanged portion of the second cover enters the large diameter portion of the opening below the eave.

Alternatively, in the preferred embodiment described above, the following configuration may be employed, in which a step is formed in the inner surface of each of the openings, whereby the opening has an upper large diameter portion and a lower small diameter portion, and the flanged portion of the second cover is inserted into the large diameter portion of the opening.

In another preferred embodiment, the substrate placing table further includes: a lifting arm that supports the lift pins; an actuator that moves the lift pins up and down via the lifting arm; and a lift pin attaching portion for attaching the lift pins to the lifting arm, wherein the lift pin attaching portion includes a concave portion provided in an upper surface of the lifting arm at a position corresponding to the lift pin, a base member to which the lift pin is screw fastened, and a clamp member for securing the base member to the lifting arm by clamping the base member, and wherein the base member has a protrusion protruding downward from a bottom face of the base member and loosely fitted into the concave portion.

In a further preferred embodiment, the first cover has a placing region for placing the substrate thereon; and the placing table body and the first cover are configured such that at least one of the following dimensional relationships is established: (i) a thickness of the first cover in the substrate placing region is larger than a thickness of the first cover in an outer region outside the substrate placing region, and (ii) a distance between a lower surface of the first cover and an upper surface of the substrate placing table body in the substrate placing region is smaller than the distance between the lower surface of the cover and the upper surface of the substrate placing table body in the outer region outside the substrate placing region.

Further, the present invention provides a substrate processing apparatus including the substrate placing tables of aforementioned variations. The substrate processing apparatus includes: a processing container, for accommodating a substrate, which is capable of maintaining a vacuum therein; the aforementioned substrate placing table for placing the substrate thereon in the processing container; a processing gas supply mechanism for supplying a processing gas into the processing container; and a plasma generation mechanism for generating a plasma of the processing gas in the processing container.

In a preferred embodiment of the substrate processing apparatus, the plasma generation mechanism has a plane antenna having a plurality of slots and microwave introduction means for introducing microwaves via the plane antenna into the processing container, and the processing gas is converted into a plasma by the introduced microwaves. Further, a high frequency bias application unit that applies a high frequency bias for drawing ions in the plasma to the substrate placing table may be further provided.

In another aspect of the present invention, there is provided a substrate placing table for placing a substrate thereon in a processing container in a substrate processing apparatus for performing treatment to the substrate in the processing container, including: a placing table body; and a substrate lifting mechanism for moving the substrate up and down with respect to the placing table body, wherein the substrate lifting mechanism has a plurality of lift pins inserted respectively into a plurality of insertion holes formed in the placing table body and to move the substrate up and down while supporting the substrate at the top end thereof, a lifting arm that supports the lift pins, a lifting mechanism for moving the lift pins up and down via the lifting arm, and a lifting arm attaching portion for attaching the lift pins to the lifting arm, wherein the lift pin attaching portion includes a concave portion provided in an upper surface of the lifting arm at a position corresponding to the lift pin, a base member to which the lift pin is screw fastened, and a clamp member for securing the base member to the lifting arm by clamping the base member, and wherein the base member has a protrusion protruding downward from a bottom face of the base member and loosely fitted into the concave portion. Further, the invention also provides a substrate processing apparatus including a processing container, the substrate placing table for placing the substrate thereon in the processing container, and a processing gas supply mechanism for supplying a processing gas into the processing container, and further optionally including a plasma generation mechanism for generating a plasma of the processing gas in the processing container.

In said another aspect of the present invention, the lower end face of the lift pin is preferably in contact with the bottom face of a screw hole formed in the base member. Further, it is preferable that the protrusion is provided at the central portion at the bottom face of the base member, the cross sectional shape is a circular shape, the concave portion is in a circular shape having larger diameter than the protrusion, a gap is formed between the inner circumferential surface of the concave portion and the protrusion and the lift pin can be positioned by moving the base member in an optional direction within the range of the gap.

The clamp member has a pressing portion for pressing the base member from above and an attaching portion fastened by a screw to the lifting arm, and can be configured such that a pressing force exerts from the pressing portion to the base member to secure the base member when the attaching portion is fastened to the lifting arm by the screw. In this configuration, the clamp member may have a connection portion between the pressing portion and the attaching portion, and may be formed in a cranked shape in a side elevational view in which the pressing portion and the attaching portion are parallel to each other and the connection portion are perpendicular to them. The clamp member of the crank structure can be configured such that a gap is formed between the lower surface of the attaching portion and the upper surface of the lifting arm when the lower surface of the pressing portion is in close contact with the upper surface of the base member. Thus, when the attaching portion is fastened to the lifting arm by the screw, the pressing portion presses, in a tilted state, the base member. The pressing surface of the pressing portion is formed preferably such that the pressing portion, in its tilted state, presses the central portion of the base member.

According to a further aspect of the invention, there is provided a substrate placing table for placing a substrate thereon in a processing container in a substrate processing apparatus for performing the plasma processing to the substrate in the processing container held in vacuum, including: a placing table body having a diameter larger than that of the substrate; a heat generation member disposed in the substrate placing table body to heat the substrate placed thereon; a cover for covering the surface of the placing table body and having a substrate placing region for placing a process object, wherein the placing table body and the first cover are configured such that at least one of the following dimensional relationships is established: (i) a thickness of the first cover in the substrate placing region is larger than a thickness of the first cover in an outer region outside the substrate placing region, and (ii) a distance between a lower surface of the first cover and an upper surface of the substrate placing table body in the substrate placing region is smaller than the distance between the lower surface of the cover and the upper surface of the substrate placing table body in the outer region outside the substrate placing region. Further, the present invention also provides a substrate processing apparatus including a processing container, the substrate placing table for placing a substrate thereon in the processing container, and a processing gas supply mechanism for supplying a processing gas into the processing container, and, further optionally including a plasma generation mechanism for generating a plasma of the processing gas in the processing container.

In the case of the above (ii), it can be configured also such that a gap is formed between the outer region outside the substrate placing region of the cover and the substrate table body. In this case, a gap may not be formed between the substrate placing region of the cover and the placing table body.

### BRIEF DESCRIPTION OF THE DRAWINGS

FIG. 1 is a schematic cross sectional view showing a schematic configuration of a plasma processing apparatus according to a first embodiment of a substrate processing apparatus of the present invention.

FIG. 2 is an enlarged cross sectional view showing a chamber wall portion of the apparatus in FIG. 1.

FIG. 3 is a view showing the structure of a plane antenna member used for the plasma apparatus in FIG. 1.

FIG. 4 is a block diagram showing the schematic configuration of a control section of the apparatus in FIG. 1.

FIG. 5 is an enlarged view showing a wafer placing table used for the plasma processing apparatus in FIG. 1.

FIG. 6 is an enlarged perspective view showing a main portion of the wafer placing table used for the plasma processing apparatus in FIG. 1.

FIG. 7 is a fragmentary enlarged cross sectional view showing a main portion of another example of the wafer placing table.

FIG. 8 is a fragmentary enlarged cross sectional view showing a main portion of a further example of the wafer placing table.

FIG. 9 is a schematic cross sectional view showing a schematic configuration of a plasma processing apparatus according to a second embodiment of the substrate processing apparatus of the present invention.

FIG. 10 is an enlarged cross sectional view showing a wafer placing table used for the plasma processing apparatus in FIG. 9.

FIG. 11 is a perspective view showing, a wafer lifting mechanism of a wafer placing table.

FIG. 12 is a perspective view showing in an enlarged scale, a lift pin attaching portion of the wafer lifting mechanism in FIG. 11.

FIG. 13 is a cross-sectional view along line A-A in FIG. 10.

FIG. 14 is a cross sectional view along line B-B in FIG. 13.

FIG. 15 is a view showing a preferred form of a clamp member in a lift pin attaching portion.

FIG. 16 is a view showing a state of clamping a base member by using the clamp member in FIG. 15.

FIG. 17 is a schematic cross sectional view showing a schematic configuration of a plasma processing apparatus according to a third embodiment of the substrate processing apparatus of the present invention.

FIG. 18 is an enlarged cross sectional view showing a wafer placing table used for the plasma processing apparatus in FIG. 17.

FIG. 19 is an enlarged cross sectional view showing a modified example of a wafer placing table.

FIG. 20 is an enlarged cross sectional view showing another modified example of the wafer placing table.

FIG. 21 is a schematic view showing a No. 1 wafer placing table where wafer temperature is simulated.

FIG. 22 is a schematic view showing a No. 2 wafer placing table where wafer temperature is simulated.

FIG. 23 is a schematic view showing a No. 3 wafer placing table where wafer temperature is simulated.

FIG. 24 is a schematic view showing a No. 4 wafer placing table where wafer temperature is simulated.

FIG. 25 is a schematic view showing a No. 5 wafer placing table where wafer temperature is simulated.

FIG. 26 is a schematic view showing a No. 6 wafer placing table where wafer temperature is simulated.

FIG. 27 is a model view showing a wafer placing table in one embodiment of the present invention where film deposition of a silicon nitride film is actually performed as plasma processing.

FIG. 28 is a model view showing a wafer placing table in a comparative example where film deposition of a silicon nitride film is actually performed as plasma processing.

FIG. 29 is a graph showing a relation between the position on the wafer and the film deposition rate when a silicon nitride film is formed by using wafer placing tables in FIG. 27 and FIG. 28.

FIG. 30 is an enlarged cross sectional view showing a wafer placing table according to a modified example of the third embodiment.

### EMBODIMENTS FOR CARRYING OUT THE INVENTION

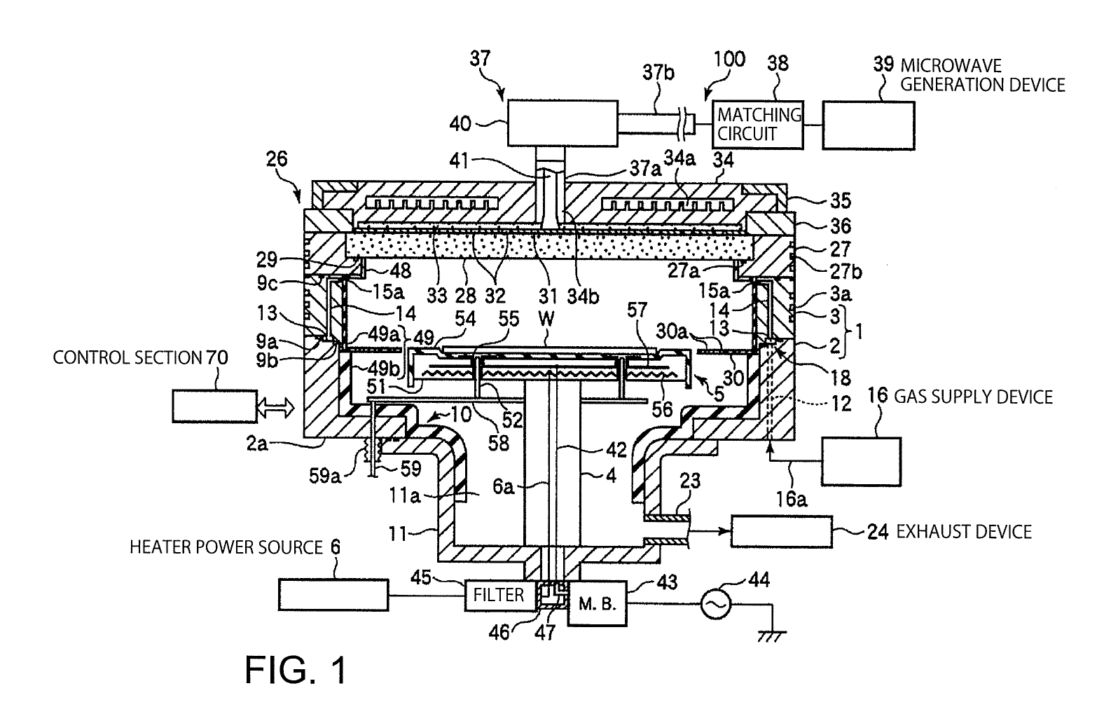

Embodiments of the present invention are to be described below with reference to appended drawings. First, a first embodiment is to be described with reference to FIG. 1 to FIG. 8. FIG. 1 is a schematic cross sectional view of plasma processing apparatus according to an embodiment of the present invention. The plasma processing apparatus 100 is configured such that a microwave plasma having high density and low electron temperature can be generated by introducing microwaves such as microwaves into a processing chamber by a radial line slot antenna (RLSA) which is a plane antenna having a plurality of slots. The plasma processing apparatus 100 can perform processing using plasma having a plasma density of 1×10¹⁰ to 5×10¹²/cm³ and a low electron temperature of 0.7 to 2 eV.

The plasma processing apparatus 100 has a grounded substantially cylindrical chamber (processing container) 1 which is configured airtightly and to which a semiconductor wafer (hereinafter simply referred to as wafer) W as a substrate is loaded. The chamber 1 is made of a metal material such as aluminum or stainless steel, and includes a housing 2 forming a lower portion thereof and a cylindrical wall 3 disposed thereover. However, the chamber 1 may be of one-piece configuration. A microwave introduction portion 26 for introducing microwaves to a processing space is disposed above the chamber 1 such that it can be opened and closed. Upon processing, the microwave introduction portion 26 is engaged in an airtightly sealed state with the upper end of the cylindrical wall 3, and the lower end of the cylindrical wall 3 is engaged with the upper end of the housing 2 in an airtightly sealed state. A cooling water flow channel 3a is formed in the cylindrical wall 3 for cooling the cylindrical wall 3, thereby preventing deterioration of the sealing performance and generation of particles caused by positional displacement, etc. of the engaging portion by thermal expansion due to the heat of the plasma.

A circular opening 10 is formed at a central portion of the bottom wall 2a of the housing 2. An exhaust member (exhaust chamber) 10 covering the opening 10 and protruding downward is connected to the bottom wall 2a, and a gas in the chamber 1 can be exhausted uniformly by way of the exhaust member 10.

A wafer placing table (substrate placing table) 5 for horizontally placing the wafer W as a substrate to be treated is disposed in the housing 2. The lower end of the placing table 5 is supported on the upper end of a cylindrical support member 4 that is supported at the central portion at the bottom of the exhaust member 10 and extends upward from the bottom. The wafer placing table 5 has a placing table body 51 made of AlN. The placing table body 51 is covered with a first cover 54 and a second cover 55. Three lift pins 52 are inserted (only two of them are shown) in the placing table body 51 for moving the wafer W up and down. Further, an ohmic heating type heater 56 is buried in the placing table body 51, and an electrode 57 is buried in the placing table body 51 on the side of the surface (above the heater 56). Detailed configuration of the wafer placing table 5 is to be described later.

A heater power source 6 is connected to the heater 56 by way of a power feed line 6a passing through the support member 4. When power is supplied from the heater power source 6 to the heater 56, the heater 56 generates heat to heat the wafer W placed on the wafer placing table 5. A noise filter circuit for blocking high frequency noise flowing to the heater power source 6 is interposed in the power feed line 6a, and the noise filter circuit is accommodated in a filter box 45. The temperature of the wafer placing table 5 is measured by thermocouple (not shown) inserted into the wafer placing table 5, the output of the heater power source 6 is controlled based on a temperature signal from the thermocouple, so that the temperature of the wafer placing table 5 can be controlled to a desired temperature in a range, for example, from a room temperature to 900° C.

As the material for the electrode 57, a high melting metal material, for example, molybdenum and tungsten can be used suitably. The electrode 57 can be formed, for example, in a mesh, grid, or spiral shape in a planar view. A high frequency power source 44 for bias application is connected to the electrode 57 by way of a power feed line 42 that passes through the inside of the support member 4. By supplying a high frequency power from the high frequency power source 44 to the electrode 57, it is possible to apply a high frequency bias to the placing table body 51 and, further, apply a high frequency bias by way of the placing table body 51 also to the wafer W thereabove. Thus, ion species in the plasma can be drawn to the wafer W. A matching box 43 having a matching circuit for matching plasma impedance with the high frequency power source 44 is interposed in the power feed line 42.

The filter box 45 and the matching box 43 are connected and integrated by a shield box 46, and attached to the lower side of the bottom wall of the exhaust chamber 11. The shield box 46 is formed of an electroconductive material, for example, aluminum or stainless steel, and has a function of shielding the leakage of microwaves.

Seal members 9a, 9b, and 9c comprising, for example, O-rings are disposed at upper and lower engaging portions of the cylindrical wall 3, to keep the engaging portions airtight. The seal members 9a, 9b, and 9c are made, for example, of a fluorine rubber.

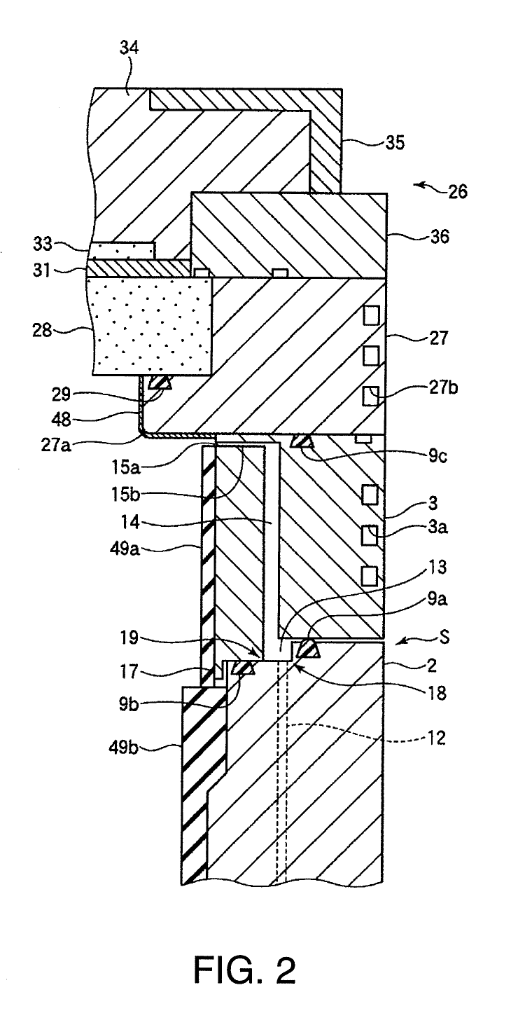

As shown in the enlarged view of FIG. 2, a plurality of gas supply channels 12 extending in the vertical direction are formed in the housing 2 at optional positions (for example, at positions equally dividing the housing 2 circumferentially into four parts). A gas supply device 16 is connected with the gas supply channels 12 by way of a gas supply pipeline 16a (refer to FIG. 1), and a predetermined processing gas is supplied from the gas supply device 16 into the chamber 1 as to be described later.

The gas supply channels 12 are connected with an annular channel 13 which is a supply communication channel of a processing gas formed at the joined surface between the upper portion of the housing 2 and the lower portion of the cylindrical wall 3. Further, a plurality of gas channels 14 connected with the annular channel 13 are formed inside the cylindrical wall 3. Further, a plurality of (for example, 32) gas introduction ports 15a are formed on the inner circumferential surface at the upper end portion of the cylindrical wall 3, each equally spaced apart in the circumferential direction, and gas introduction channels 15b extend horizontally in the cylindrical wall 3 from the gas introduction ports 15a. The gas introduction channels 15b are in communication with the gas channels 14 extending vertically in the cylindrical wall 3.

The annular channel 13 is defined with a gap between a step 18 and a step 19 to be described later at the joined surface between the upper portion of the housing 2 and the lower portion of the cylindrical wall 3. The annular channel 13 extends circularly within a horizontal plane so as to surround the processing space above the wafer W.

The annular channel 13 is connected by way of the gas supply channels 12 to the gas supply device 16. The annular channel 13 has a function as gas distribution means for equally distributing gas to each of the gas channels 14, and prevents localized supply of the processing gas to a specified one of gas introduction ports 15a.

As described above, since the gas from the gas supply device 16 can be supplied uniformly by way of each of the gas supply channels 12, the annular channel 13, and each of the gas channels 14 from the 32 gas introduction ports 15a into the chamber 1, this can improve the uniformity of the plasma in the chamber 1.

A protrusion 17 suspending downward in a flared shape (skirt-like shape) is formed at the lower end of the inner circumferential surface of the cylindrical wall 3. The protrusion 17 is disposed so as to cover the boundary (joined surface) between the cylindrical wall 3 and the housing 2, and serves to prevent the plasma from acting directly on the seal member 9b made of a material liable to be degraded when exposed to the plasma.

The step 18 is formed at the upper end of the housing 2, the step 19 is formed at the lower end of the cylindrical wall 3, and the annular channel 13 is defined with the combination of the steps 18 and 19. The height (step) of the step 19 is larger than the height (step) of the step 18. Therefore, in a state where the lower end of the cylindrical wall 3 and the upper end of the housing 2 are engaged, a protruding surface of the step 19 and a non-protruding surface of the step 18 abut with each other on the side where the seal member 9b is disposed, whereas a non-protruding surface of the step 19 and a protruding surface of the step 18 do not abut with each other on the side where the seal member 9a is disposed to form a gap between both of them. This can reliably abut the protruding surface of the step 19 and the non-protruding surface of the step 18 with each other and the seal member 9b can reliably seal the gap between them. That is, the seal member 9b functions as a main seal portion. Since the seal member 9a is interposed between the non-protruding surface of the step 19 and the protruding surface of the step 18 in the non-abutment state, it has a function as an auxiliary seal portion for keeping the airtightness at such an extent as not to cause the gas to leak outside the chamber 1.

As shown in FIG. 1, a cylindrical liner 49 made of quartz is disposed on the inner circumference of the chamber 1. The liner 49 has an upper liner 49a mainly covering the inner surface of the cylindrical wall 3, and a lower liner 49b being contiguous with the upper liner 49a and mainly covering the inner circumference of the housing 2. The upper liner 49a and the lower liner 49b have a function of preventing metal contamination by the constituent material of the chamber 1 and preventing generation of abnormal electric discharge between the wafer placing table 5 and the side wall of the chamber 1 due to the high frequency power. With a view point of reliably preventing the abnormal electric discharge, the thickness of the lower liner 49b nearer to the wafer placing table 5 is made larger than the thickness of the upper liner 49a, and the lower liner 49b covers a range to a height at the position lower than the wafer placing table 5, specifically, to a height at the position in the midway of the exhaust member (exhaust chamber) 11. Further, an annular baffle plate 30 which is made of quartz and has a plurality of exhaust holes 30a is disposed around the wafer placing table 5 for uniformly exhausting the inside of the chamber 1. The upper liner 49a and the lower liner 49b may also be formed integrally.

An exhaust pipe 23 is connected to the lateral side of the exhaust member 11 and the exhaust pipe 23 is connected with an exhaust device 24 including a high speed vacuum pump. When the exhaust device 24 is operated, the gas in the chamber 1 is discharged uniformly into the space 11a in the exhaust member 11, and then discharged by way of the exhaust pipe 23. This can depressurize the inside of the chamber 1 to a predetermined vacuum degree, for example, 0.133 Pa at a high speed.

A load/unload port for loading and unloading the wafer W and a gate valve for opening and closing the load/unload port are disposed on the side wall of the housing 2 (both not shown).

The upper portion of the chamber 1 is opened and the microwave introduction portion 26 is disposed so as to airtightly close the opening. The microwave introduction portion 26 can be moved by an opening/closing mechanism (not shown), by which the opening at the upper portion of the chamber 1 can be opened and closed.

The microwave introduction portion 26 has a lid frame 27, a transmission plate 28, a plane antenna 31, and a retardation material 33 in order from the side of the wafer placing table 5. The transmission plate 28, the plane antenna 31 and the retardation material 33 are covered with a cover member 34 comprising a conductive material such as stainless steel, aluminum, and aluminum alloy. The cover member 34 is pressed downward by an annular retaining ring 35 having an L-shaped cross sectional form, and the transmission plate 28 is pressed onto the lid frame 27 by an annular support member 36, by which each of constituent members of the microwave introduction portion 26 is integrated. An O-ring 29 is disposed between the transmission plate 28 and the lid frame 27. When the microwave introduction portion 26 is mounted to the chamber 1, the upper end of the chamber 1 and the lid frame 27 are sealed with a seal member 9c. Cooling water flow channels 27b are formed at the outer circumferential portion of the lid frame 27, thereby suppressing thermal expansion of the lid frame 27 due to the heat of the plasma. This can prevent positional displacement of the joined portions caused by thermal expansion, and deterioration of the sealing performance of the joined portions that may be caused thereby, as well as generation of particles due to contact with the plasma.

The transmission plate 28 comprises a dielectric body, for example, quartz, Al₂O₃, AlN, sapphire, and ceramics such as SiN, and functions as a microwave introduction window that allows microwaves to transmit therethrough and introduces the microwaves into the processing space in the chamber 1. The lower surface of the transmission plate 28 (surface on the side of the wafer placing table 5) may be formed as a planar surface. However, this is not restrictive and concave portions or trenches may be formed on the lower surface of the transmission plate 28 for unifying the microwaves and stabilizing the plasma. A protrusion 27a protruding to the space in the chamber 1 is formed at the inner circumferential surface of the annular lid frame 27, and the outer circumference of the transmission plate 28 is supported on the upper surface of the protrusion 27a. A seal member 29 is disposed between the upper surface of the protrusion 27a and the lower surface at the outer circumference of the transmission plate 28 to airtightly seal a portion between both of the surfaces. Accordingly, when the microwave introduction portion 26 is mounted on the chamber 1, the inside of the chamber 1 can be kept airtight.

The plane antenna 31 has a disk-like shape. The plane antenna 31 is positioned over the transmission plate 28 and is engaged to the lower surface at the outer circumference of the cover member 34. The plane antenna 31 is made, for example, of a copper plate, which is gold or silver plated at the surface, an aluminum plate, a nickel plate, or a brass plate. A number of microwave emission holes (slots) 32 for emitting electromagnetic waves such as microwave are formed at a predetermined pattern to the plane antenna 31, and each of the slots 32 passes through the plane antenna 31.

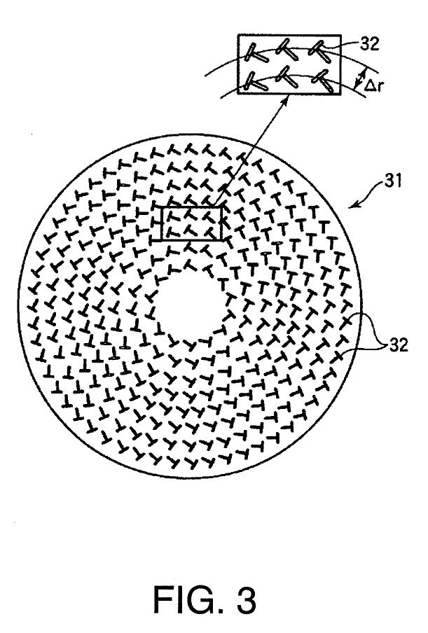

For example, as shown in FIG. 3, the slots 32 can be arranged such that two long slots 32 are paired. Typically, paired slots 32 are arranged so as to form a “T”-shape to each other, and such paired slots are arranged concentrically. The length and the arrangement distance of the slots can be determined according to the wavelength (λg) of microwaves and, for example, the distance between the slot pairs adjacent to each other in the radial direction (Δr in FIG. 2) may be from λg/4 to λg. Further, the slot 32 is not restricted to the illustrated long linear shape but may be other shapes, for example, an arc shape. Further, the arrangement of the slots 32 is not restricted to the illustrated example but they may be arranged, for example, in a spiral or radial fashion in addition to the concentric fashion.

The retardation material 33 is disposed over the plane antenna 31. The retardation material 33 can be formed of a material having a higher dielectric constant than that of vacuum, for example, quartz, ceramics, fluorine resins such as polytetrafluoroethylene or polyimide resins. The wavelength of microwave is longer in vacuum. Accordingly, by providing the retardation material 33 of an appropriate material and shape and size, the wavelength of the microwaves propagating in the region of the retardation material 33 can be shortened to control the generated plasma. While the opposing surfaces of the plane antenna 31 and the transmission plate 28 may be in close contact with or spaced apart from each other (gap is formed between them), they are preferably in close contact with each other. In the same manner, while the opposing surfaces of the retardation material 33 and the plane antenna 31 may be in close contact with or spaced apart from each other, they are preferably in close contact with each other.

Cooling water channels 34a are formed inside the cover member 34 and, by flowing cooling water therethrough, the cover member 34, the retardation material 33 that is in direct or indirect contact with the cover member 34, the plane antenna 31, the transmission plate 28, and the lid frame 27 can be cooled. This can prevent these members from being deformed and damaged, and generate stable plasma. The cover member 34 is grounded.

An opening 34b is formed at the central portion of the upper wall of the cover member 34, and a waveguide tube 37 is connected to the opening 34b. A microwave generation device 39 is connected to the end of the waveguide tube 37 by way of a matching circuit 38. Thus, microwaves at a frequency, for example, of 2.45 GHz generated by the microwave generation device 39 are propagated by way of the waveguide tube 37 to the plane antenna 31. The frequency of the microwaves may also be other frequencies such as 8.35 GHz and 1.98 GHz.

The waveguide tube 37 has a coaxial waveguide tube 37a having a circular cross sectional shape and extending upward from the opening 34b of the cover member 34, and a rectangular waveguide tube 37b that is connected to the upper end of the coaxial waveguide tube 37a by way of a mode transducer 40 and extends in the horizontal direction. The mode transducer 40 between the rectangular waveguide tube 37b and the coaxial waveguide tube 37a has a function of transducing the microwave propagating in the rectangular waveguide tube 37b in a TE mode to a TEM mode. An inner conductor 41 extends along the center of the coaxial waveguide tube 37a, and the inner conductor 41 is connected and fixed at the lower end thereof to the center of the plane antenna 31. Thus, the microwaves are radially uniformly propagated with high efficiency to the plane antenna 31 by way of the inner conductor 41 of the coaxial waveguide tube 37a.

The protrusion 27a of the lid frame 27 made of aluminum functions as a counter electrode to the wafer placing table 5 (electrode 57 in the wafer placing table 5). The surface of the protrusion 27a faces the plasma generation region in the chamber 1, is consumed by sputtering when exposed to strong plasma, and generates contamination. In order to prevent this, a silicon film 48 is coated as a protective film on the surface of the protrusion 27a facing the plasma generation region in the chamber 1. The silicon film 48 protects the surface of the lid frame 27, particularly, the protrusion 27a against the oxidation effect or sputtering effect by the plasma, and prevents generation of contamination derived from aluminum, etc. contained in the material of the lid frame 27. The silicon film 48 may be crystalline or amorphous. Further, since the silicon film 48 is electroconductive, it also has a function of efficiently forming a path of high frequency current flowing from the wafer placing table 5 to the lid frame 27 as a counter electrode while being spaced by the plasma processing space, thereby suppressing short circuit and abnormal electric discharge at other portions.

While the silicon film 48 can be formed by a thin film forming technique such as a PVD method (physical vapor deposition method), a CVD method (chemical vapor deposition method), or a plasma spraying method, the plasma spraying method is preferred among them because a thick film can be formed relatively simply and at a low cost.

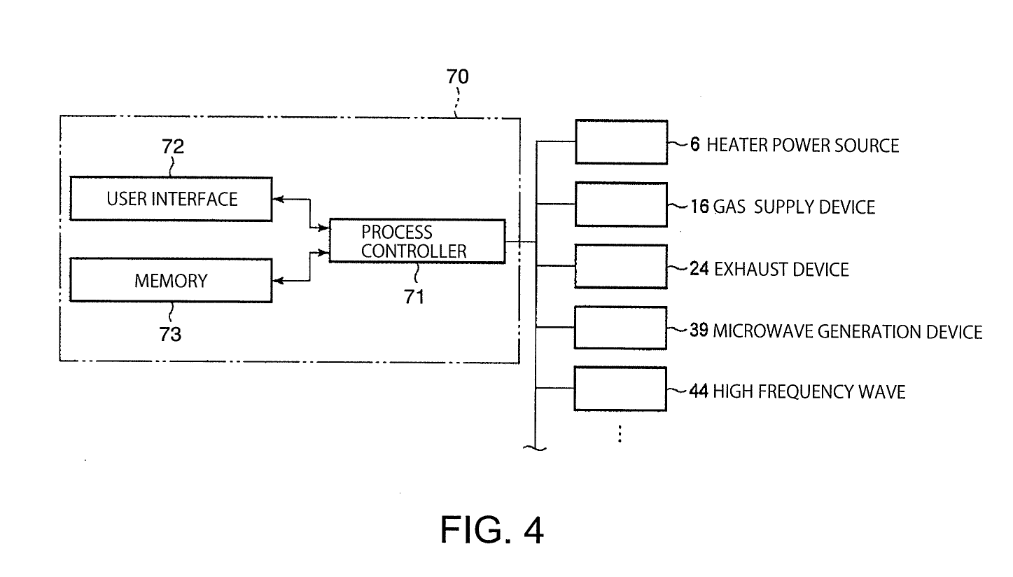

Each of the functional parts constituting the microwave plasma processing apparatus 100 is connected to and controlled by a control section 70. The control section 70 comprises a computer and, as shown in FIG. 4, includes a process controller 71 having a microprocessor, a user interface 72 connected to the process controller, and a memory area 73.

The process controller 71 controls each of the functional parts, for example, the heater power source 6, the gas supply device 16, the exhaust device 24, the microwave generation device 39, and the high frequency power source 44 such that processing conditions such as temperature, pressure, gas flow rate, microwave output, and high frequency power for applying bias are at desired conditions in the plasma control apparatus 100.

The user interface 72 has a key board on which an operator conducts command input operation, etc. for administrating the plasma processing apparatus 100, and a display that visualizes and displays the operation situation of the plasma processing apparatus 100. Further, the memory area 73 contains a processing recipe that defines the processing conditions for various processing executed by the plasma processing apparatus 100, and a control program that causes each of the functional parts of the plasma processing apparatus 100 to conduct predetermined operations under the control of the process controller 71 based on the processing conditions defined by the processing recipe.

The control program and the processing recipe are stored in a memory medium of the memory area 73. The memory medium may be either a fixed medium such as a hard disk or a semiconductor memory, or a mobile medium such as CDROM, DVD, and flash memory. Further, instead of storing the control program and the processing recipe in the memory medium, they may be sent from other apparatus, for example, by way of an exclusive line to the plasma processing apparatus 100.

By reading out the optional processing recipe from the memory area 73, as necessary, based on the instruction from the user interface 72 and having the process controller 71 to execute the same, desired processing is performed in the plasma processing apparatus 100 under the control of the process controller 71.

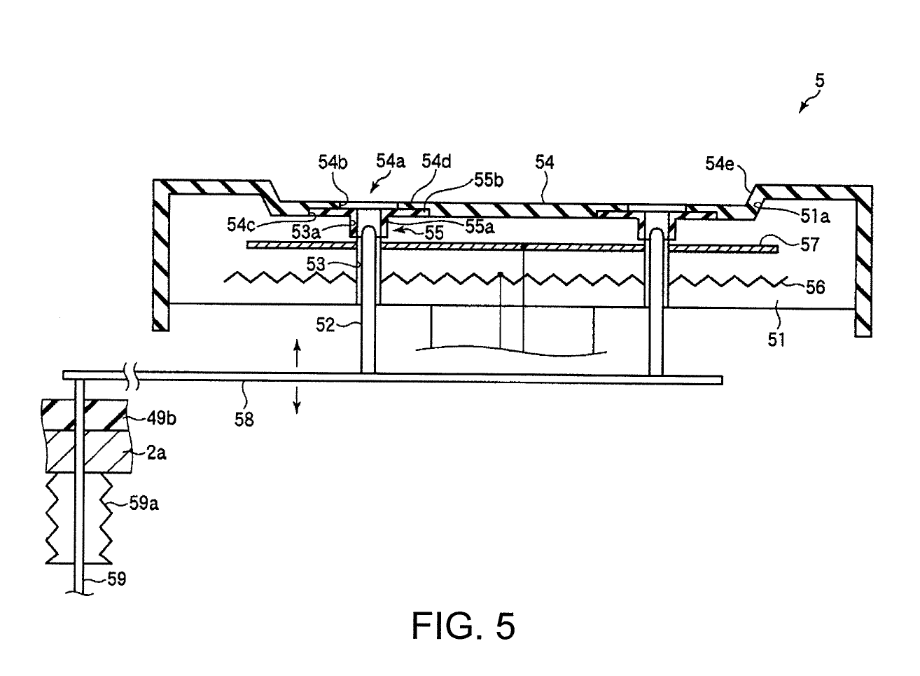

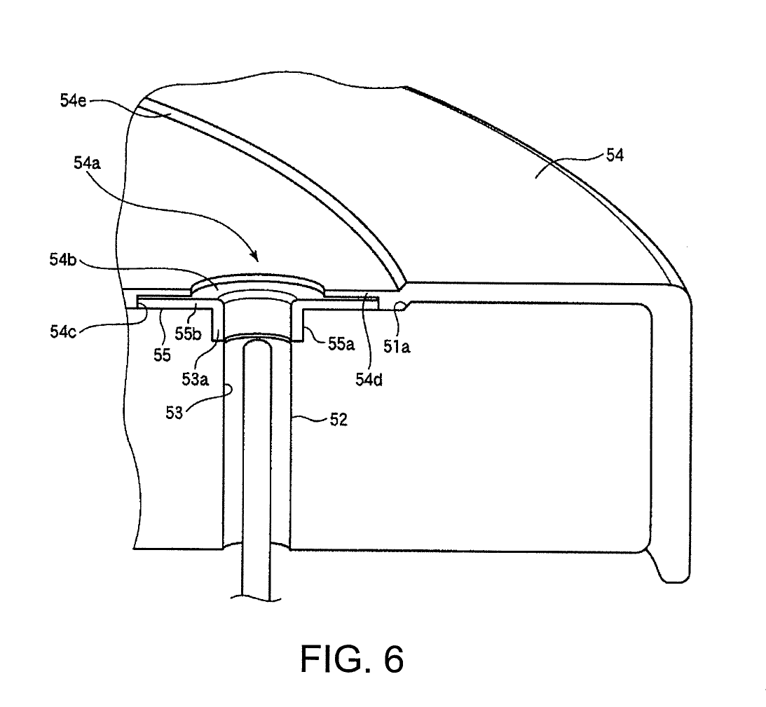

Then, the wafer placing table 5 is to be described specifically. FIG. 5 is an enlarged cross sectional view showing the wafer placing table 5 and FIG. 6 is an enlarged perspective view showing a main portion thereof. The wafer placing table 5 is supported inside the housing 2 by a cylindrical support member 4 extending upward from the center of the bottom of the exhaust chamber 11 as described above. The placing table body 51 of the wafer placing table 5 comprises AlN which is a ceramic material having good thermal conductivity. Three insertion holes 53 (only two of them are shown) for allowing lift pins 52 to insert therethrough are passed through vertically the placing table body 51. The upper portion of the insertion hole 53 forms a large diameter hole portion 53a having a larger diameter. A first cover 54 is formed of quartz at high purity. The first cover 54 covers the upper surface and the lateral side of the placing table body 51. An opening 54a of a larger diameter than that of the through hole 53 is formed in the first cover 54, with the opening 54a being located at a position associated with the through hole 53. A step is formed on the inner circumferential surface of the opening 54a of the first cover 54. Thus, the opening 54a has a small diameter portion 54b on the upper side and a large diameter portion 54c on the lower side.

A second cover 55 is also formed of quartz at high purity. The second cover 55 is formed as a member separate from the first cover 54. The second cover 55 covers at least a portion of the inner circumferential surface of the insertion hole 53 (preferably, upper portion of the insertion hole 53) and at least a portion of the inner surface of the opening 54a, thereby preventing the surface of the placing table body 51 comprising AlN near the upper end of the insertion hole 53 from being exposed to the plasma generated in the chamber 1. Specifically, the second cover 55 has a cylindrical portion 55a, and a flange portion 55b extending from the upper end of the cylindrical portion 55a to the outside. The cylindrical portion 55a is inserted into the large diameter hole portion 53a at the upper portion of the insertion hole 53 and covers the inner circumferential surface of the large diameter hole portion 53a. The flange portion 55b enters into the large diameter portion 54c of the opening 54a and is positioned below an eave 54d of the first cover 54 extending above the large diameter portion 54c. Accordingly, the flange portion 55b covers the inner surface of the large diameter portion 54c of the opening 54a and the upper surface of the placing table body 51 exposed as a result of forming the opening 54a (large diameter portion 54c) in the first cover 54. With the configuration described above, the entire region for the upper surface of the placing table body 51 and the upper region of the inner circumferential surface of the insertion hole 53 are covered by the first cover 54 and the second cover 55 and, accordingly, AlN is not exposed in the regions.

A concave portion 51a is formed in the upper surface of the placing table body 51. Further, a concave portion 54e corresponding to the concave portion 51a is formed in the upper surface of the first cover 54. The concave portion 54e forms a placing portion (placing region) for the wafer W.

The lift pin 52 to be inserted into the insertion hole 53 is secured to a pin support member 58. That is, the lift pin 52 is formed as a fixed pin. The pin support member 58 is connected with a lifting rod 59 extending in the vertical direction and the lift pin 52 is moved up and down by way of the pin support member 58 by moving the lifting rod 59 up and down by an actuator (not shown). A numeral 59a denotes bellows disposed so as to allow the lifting rod 59 to move up and down while ensuring the airtightness inside the chamber 1.

Then, the operation of the plasma processing apparatus 100 having been configured as described above is to be explained. First, the wafer W is loaded into the chamber 1 while being placed on a wafer arm of a wafer transfer mechanism (not shown). Then, the lift pins 52 are moved upward, the wafer W is transferred from the wafer arm to the lift pin 52, and the lift pins 52 are moved down to place the wafer W on a susceptor, that is, on the substrate placing table 5. Then, a processing gas necessary for a desired treatment (oxidizing gas, for example, O₂, N₂O, NO, NO₂, and CO₂ in the oxidation treatment, a nitriding gas such as N₂, and NH₃ in the nitridation treatment, a film deposition gas such as Si₂H₆ and N₂ or NH₃ and, optionally, a rare gas such as Ar, Kr, and He in addition to the gases described above in the film deposition treatment) is introduced at a predetermined flow rate from the gas supply device 16 by way of the gas introduction port 15a into the chamber 1.

Then, microwaves from the microwave generation device 39 are introduced by way of the matching circuit 38 to the waveguide tube 37, passed through the rectangular waveguide tube 37b, the mode transducer 40, and the coaxial waveguide tube 37a sequentially, and supplied by way of the inner conductor 41 to the plane antenna member 31, and emitted from the slot holes 32 in the plane antenna member 31 by way of the transmission plate 28 into the chamber 1.

The microwaves propagate in a TE mode in the rectangular waveguide tube 37b, the microwaves in the TE mode are transduced into a TEM mode by the mode transducer 40 and then propagated in the coaxial waveguide tube 37a to the plane antenna member 31. An electromagnetic field is formed in the chamber 1 by the microwaves that are emitted from the plane antenna member 31 by way of the transmission plate 28 to the chamber 1 to convert the processing gas into plasma.

When the microwaves are emitted from the plurality of slot holes in the plane antenna member 31, the plasma becomes a low electron temperature plasma at a high density of about 1×10¹⁰ to 5×10¹²/cm³ and at an electron temperature near the wafer W of about 1.5 eV or lower. By using such plasma, the wafer W can be treated while suppressing the plasma damage.

Upon plasma processing in this embodiment, a high frequency power at a predetermined frequency is supplied from the high frequency power source 44 to the electrode 57 of the placing table body 51 to apply a high frequency bias to the placing table body 51 and, further, the high frequency bias is applied by way of the placing table body 51 to the wafer W thereover. This provides an effect of drawing ion species in the plasma into the wafer W while keeping the low electron temperature of the plasma, and it is possible to increase the processing rate of the plasma processing and improve the uniformity within the plane of the plasma processing. The frequency of the high frequency power for applying the high frequency bias is preferably within a range, for example, from 100 kHz to 60 MHz and, more preferably, within a range from 400 kHz to 13.56 MHz. The power of the high frequency power as the power density per unit area of the wafer W is preferably within a range, for example, from 0.2 to 2.3 W/cm². Further, the high frequency power itself is preferably within a range from 200 to 2,000 W.

During plasma processing as described above, since the placing table body 51 is formed of AlN. Thus, when the placing table body 51 is exposed to the plasma, particles containing Al are generated, and they are deposited on the wafer W to result in contamination. Particularly, when the high frequency bias is applied to the wafer placing table 5 as in this embodiment, the contamination level may be possibly made higher by the ion drawing effect, etc.

Then, in this embodiment, the first cover 54 and the second cover are disposed in the manner described above. Accordingly, an AlN portion to be exposed to the plasma can be eliminated substantially and the AI contamination level can be lowered extremely. In addition, since the second cover 55 is a member separate from the first cover 54, there is no possibility of generating such an excess stress as to cause destruction of the covers 54, 55 (particularly, the second cover 55) due to the difference of thermal expansion between AlN that forms the placing table body 51 and quartz that forms the first and the second covers 54 and 55.

Further, with the view point of decreasing the contamination, it is preferred that the inner surface of the insertion hole 53 is entirely covered with quartz, but a clearance between the lift pin 52 and the inner circumferential surface of the second cover 55 becomes extremely small in this case. Since there is a limit for the accuracy of the position and the verticality of the lift pin 52, when the clearance is small, there may be a possibility of generating such disadvantages that the lift pin 52 and the inner circumferential surface of the second cover 55 rub against each other, the lift pin 52 raises the second cover 55 and further the first cover 54, or the lift pin 52 is flexed. Therefore, such disadvantages are prevented by fitting the cylindrical portion 55a of the second cover 55 in the large diameter hole portion 53a at the upper portion of the insertion hole 53 and causing the second cover 55 not to be present at the lower portion of the insertion hole 53. Even when AlN is exposed at the lower portion of the insertion hole 53, since the plasma flux enters only slightly as far as the inside of the insertion hole 53, this results in no remarkable effect. Further, while a path through which particles can pass is present between the eave 54d of the first cover 54 and the flange portion 55b of the second cover 55, passage of the particles can be minimized by increasing the length of the path, for example, increasing the overlap length between the eave 54d and the flange portion 55b.

In this embodiment, since the lift pin 52 is a fixed pin fixed to the pin support member 58, when positioning has been made properly in the initial stage, the possibility in which the lift pin 52 and the inner circumferential surface of the second cover 55 or the inner surface of the insertion hole 53 are in contact with each other is greatly lowered compared with the case of using a floating pin.

Further, since the flange portion 55b of the second cover 55 enters the inside of the large diameter portion 54c below the opening 54a and is positioned under the eave 54d of the first cover 54, there is no possibility that the second cover 55 is attached to the wafer W and detached. That is, in a case where the second cover 55 is merely placed over the first cover 54, there may be a possibility that the second cover 55 may be adsorbed to the wafer W and detached when the processing is completed and the wafer W is moved upward. Particularly, when the wafer is electrostatically adsorbed, electrostatic adsorption force may sometimes remain even after the voltage has been turned off, and there is a high possibility that the second cover 55 may be adsorbed to the wafer W and detached. However, in this embodiment, since the flange portion 55b of the second cover 55 is positioned under the eave 54d of the first cover 54, the second cover 55 is not detached while being adsorbed to the wafer W even when such adsorption force exerts.

When the processing was actually performed in the plasma processing apparatus according to this embodiment, the Al contamination level at 1.0×10¹⁰ atoms/cm² in the existent apparatus where the AlN exposed potion is present at the periphery of the insertion hole could be lowered to 5.0×10⁹ atoms/cm².

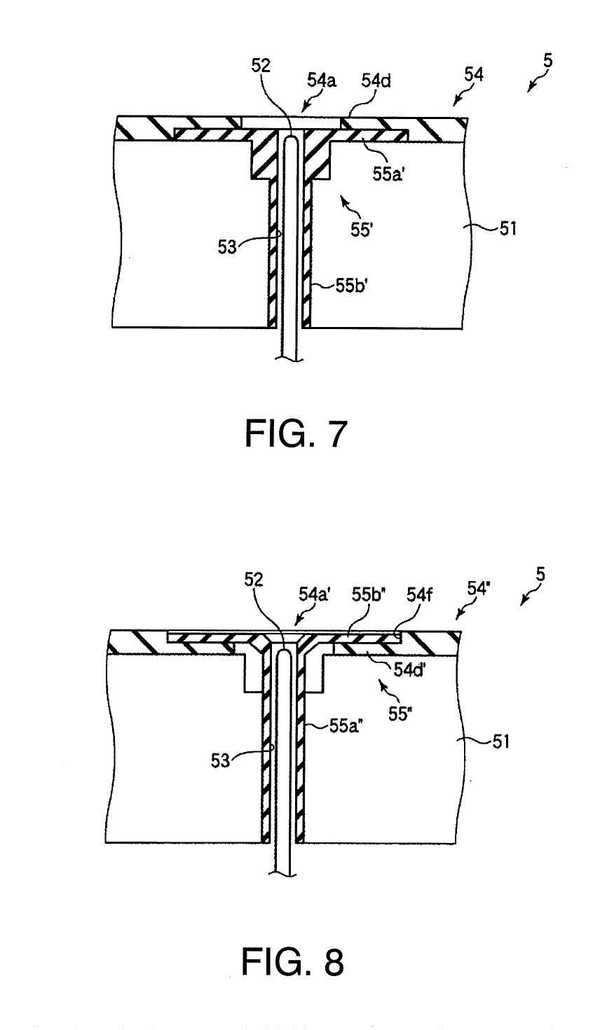

Then, a modified example of the wafer placing table 5 is to be described. FIG. 7 is a fragmentary enlarged cross sectional view showing a main portion of another example of the wafer placing table 5. This example is different from the embodiment described previously only in that a second cover 55′ that has a cylindrical portion 55a′ reaching as far as the lower end of the insertion hole 53 is used instead of the cylindrical portion 55a.

In the wafer placing table 5 described previously, the length of the cylindrical portion 55a is shortened so as to cover only the inner circumferential surface of the large diameter hole portion 53a at the upper portion of the insertion hole 53 while attaching importance to the prevention of friction between the lift pin 52 and the inner circumferential surface of the cover 55. However, when it is rather intended to prevent contamination generated by the exposure of the inner circumferential surface of the insertion hole 53 to the plasma than generation of particles caused by friction, a structure shown in FIG. 7 is suitable.

Then, a further modified example of the wafer placing table 5 is to be described with reference to FIG. 8. In this example, a concave portion 54f is formed in a first cover 54″, with the concave portion 54f being located at the periphery of an opening 54a′ associated with the insertion hole 53. A second cover 55″ has a flange portion 55b″ inserted into the concave portion 54f and a cylindrical portion 55a″ extending as far as the lower end of the insertion hole 53. In this example, the possibility of causing friction between the lift pin 52 and the cylindrical portion 55a″ is increased and the second cover 55″ may possibly be adsorbed to the wafer W. However, since the path through which the particles pass is not present between the first cover 54″ and the second cover 55″ and the AlN exposed portion is not present at all also in the insertion hole 53, this is extremely advantageous for the suppression of the particles. Further, the structure is relatively simple. The configuration shown in FIG. 8 can be regarded as that the opening has a large diameter portion on the upper side (concave portion 54f) and a small diameter portion on the lower side, and the flange portion 55b″ is inserted into the large diameter portion (concave portion 54f) of the opening.

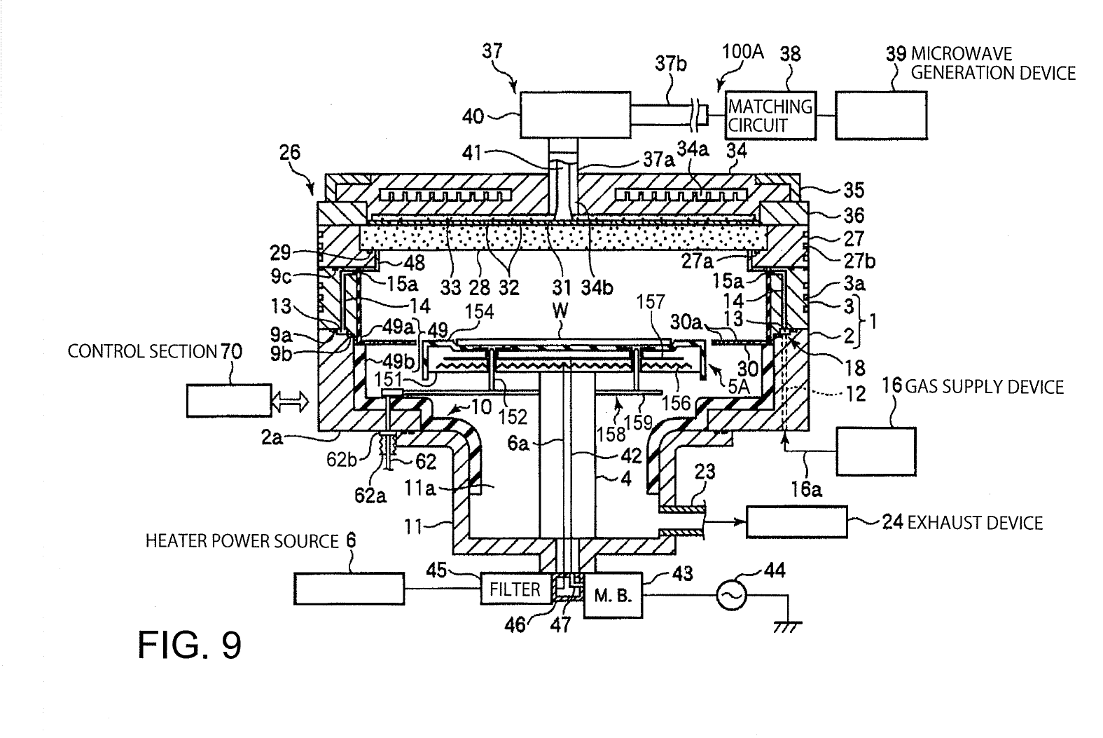

Then, a plasma processing apparatus 100A of the substrate processing apparatus according to the second embodiment of the invention is to be described. The second embodiment is different from the first embodiment mainly in the lift pin attaching structure of the wafer lifting mechanism of the wafer placing table, and other portions are substantially identical with those of the first embodiment. In FIGS. 9 to 16 showing the second embodiment, portions identical with those of the first embodiment carry the same reference numerals for which duplicate explanation is to be omitted. Further, while the plasma processing apparatus 100A according to the second embodiment has the configuration of the plasma processing apparatus 100 according to the first embodiment shown in FIGS. 2 to 4 in the same manner, duplicate explanation therefor is also to be omitted. Further, the configuration of the heater 156, the configuration of the electrode 157 and the power supply to the electrode 157 in the second embodiment are identical with the configuration of the heater 56, the configuration of the electrode 57, and the power supply to the electrode 57 in the first embodiment respectively, and duplicate explanation therefor is also to be omitted.

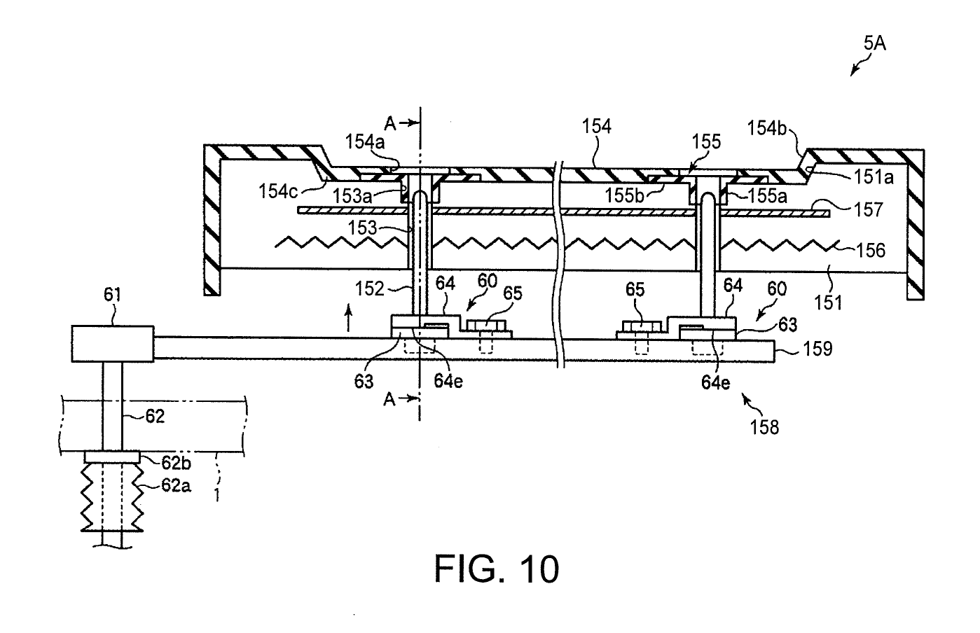

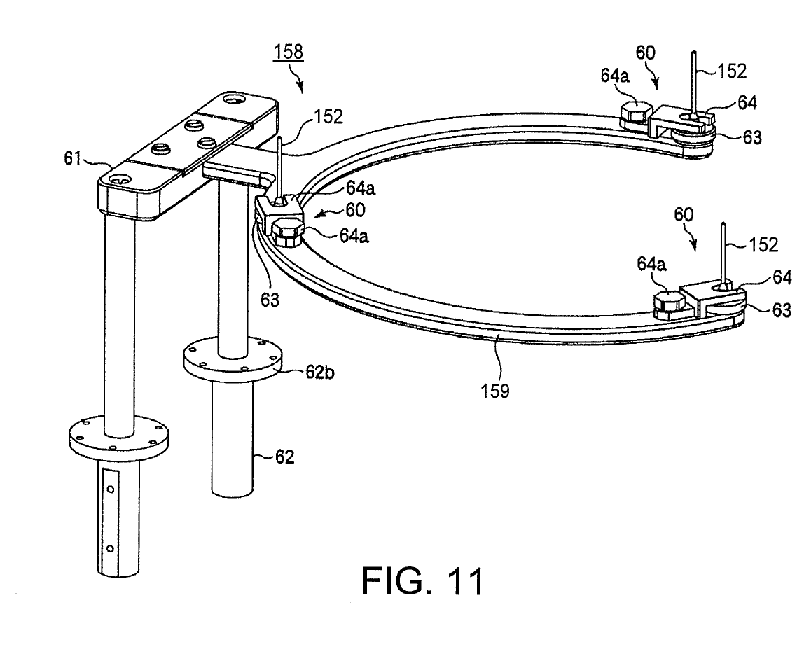

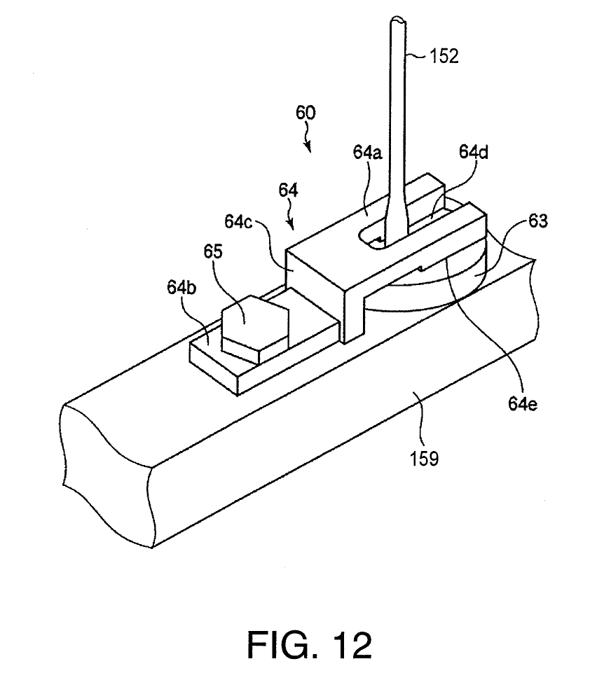

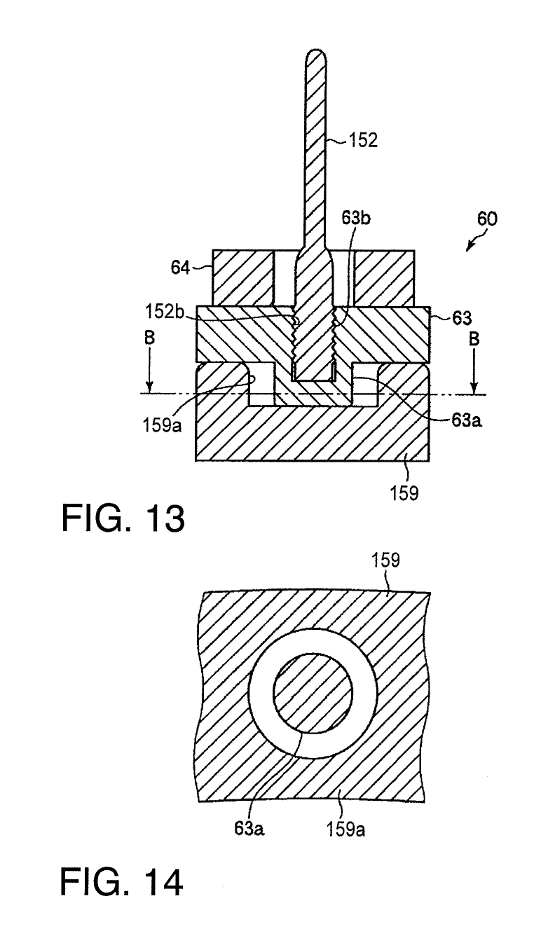

A wafer placing table 5A according to the second embodiment is to be described in details. FIG. 10 is an enlarged cross sectional view showing the wafer placing table (substrate placing table) 5A of the plasma processing apparatus 100A shown in FIG. 9, FIG. 11 is a perspective view showing a wafer lifting mechanism (substrate lifting mechanism) of the wafer placing table 5A, FIG. 12 is an enlarged perspective view showing a lift pin attaching portion 62 of the wafer lifting mechanism, FIG. 13 is a cross sectional view along line A-A in FIG. 5, and FIG. 14 is a cross sectional view along line B-B in FIG. 13.

As described above, the wafer placing table 5A is disposed in a housing 2 in a state supported by a cylindrical support member 4 extending upward from the center of the bottom of an exhaust chamber 11. A placing table body 151 of the wafer placing table (substrate placing table) 5A comprises AlN which is, for example, a ceramic material having good thermal conductivity. Three insertion holes 153 (only two of them are shown in FIG. 10) into which lift pins 152 are inserted are passed through vertically inside the placing table body 151. The upper portion of the insertion hole 153 has a large diameter hole portion 153a having a larger diameter. A first cover 154 is made of quartz at high purity and covers the upper surface and the lateral side of the placing table body 151. An opening 154a of a larger diameter than that of the through hole 153 is formed in the first cover 154 at a position corresponding to the through hole 153. A second cover 155 made of quartz at high purity that covers the opening 154a of the first cover 154 and the inner surface of the large diameter hole portion 153a at the upper portion of the insertion hole 153 is disposed. A hole into which the lift pin 152 is inserted is formed at the center of the second cover 155. The second cover 155 has a cylindrical portion 55a that is fitted in the large diameter hole portion 153a at the upper portion of the insertion hole 153 and defines an insertion hole for the lift pin 152, and a flange portion 155b that extends outward from the upper end of the cylindrical portion 155a and covers a portion of the inner surface of the opening and the upper surface of the placing table body 151 at the periphery of the upper end of the insertion hole 153.

A concave portion 151a is formed in the upper surface of the placing table body 151 at a position associated with a section at which to place the wafer W. Then, a convex portion 154c protruding downward is formed at the central portion of the first cover 154 so as to fit the concave portion 151a. A concave portion 154b is formed on the upper surface of the first cover 54 on the side opposite to the convex portion 154c and the bottom of the concave portion 154b forms a wafer placing portion for placing the wafer W. As described above, by the fitting of the convex portion 154c of the first cover 154 to the concave portion 151a, the first cover 154 is not detached from the placing table body 151.

The configuration described above is identical with that explained in the first embodiment and, accordingly, it has the same advantageous effects as those of the first embodiment.

As shown in FIG. 11, the wafer lifting mechanism (substrate lifting mechanism) 158 includes the three lift pins 152 to be inserted through the insertion holes 153, a lifting arm 159 for supporting the lift pins 152 and moving them up and down, a lift pin attaching portion 60 for attaching each of the lift pins 152 to the lifting arm, a lifting arm holding portion 61 for holding the lifting arm 159, and lifting shafts 62 extending downward from the lifting arm holding member 61 and connected with an actuator (not shown) such as a cylinder disposed outside of the chamber 1. The lift pins 152 are moved up and down by way of the lifting arm 159 by moving the lifting shaft 62 up and down by the actuator (not shown). As shown in FIG. 10, bellows 62a for allowing the lifting shaft 62 to move up and down while ensuring the airtightness in the chamber 1 are disposed below the chamber 1. The bellows 62a are attached to a bellows attaching flange 62b disposed thereabove.

As shown in FIGS. 12 and 13, the lift pin attaching portion 60 includes a concave portion 159a formed in the upper surface of the lifting arm 159, with the concave portion 159a being located at a position associated with the lift pin 52, a substantially disk-shaped base member 63 having a protrusion 63a loosely fitted in the concave portion 159a, and a clamp member 64 that is screwed to the lifting arm 159 by a screw 65, and presses the upper surface of the base member 63 to clamp the base member 63. The protrusion 63a of the base member 63 is a portion that protrudes downward from the central portion of the bottom of the base member 63 that is in face-to-face contact with the upper surface of the lifting arm 159. The base member 63 is not restricted to the disk-like shape but may be in any shape so long as it can be clamped by the clamp member 64. For example, it may also be a polygonal shape such as a quadrangular shape or a trigonal shape in a plan view.

As shown in FIG. 13, the base member 63 has a female screw 63b extending downward inside the base member 63 vertically from the central portion of the upper surface of the base member 63 to the upper surface. A male screw 152b is formed at the base end portion of the lift pin 152. The lift pin 152 is attached vertically to the base member 63 by screwing together the male screw 152b and the female screw 63b.

The bottom face of the female screw 63b of the base member 63 and the bottom face of the lift pin 152 are fabricated precisely such that the faces are in face-to-face contact with no gap and the faces have a high verticality to the axial line of the lift pin 152. Close contact between the bottom face of the female screw 63b of the base member 63 and the bottom face of the lift pin 152 is advantageous in that the verticality of the lift pin 152 to the bottom face of the female screw 63b can be ensured irrespective of a minute clearance present inevitably at the screw coupling portion between the male screw 152b and the female screw 63b. Further, the bottom face of the base member 63 and the upper surface of the lifting arm 159 are also fabricated precisely such that the faces are in face-to-face contact with no gap. Further, the bottom face of the female screw 63b of the base member 63 and the bottom face of the base member 63 have high parallelism. Accordingly, when they are assembled as shown in FIGS. 12 and 13, high verticality of the axial line of the lift pin 152 to the upper surface of the lifting arm 159 can be ensured, and the lift pin 152 can be secured to the lifting arm 159 with no rattling.

Further, as shown in FIG. 14, both of the concave portion 159a and the protrusion 63a are circular in a plan view and, further, a gap is formed between the inner circumferential surface of the concave portion 159a and the outer circumferential surface of the protrusion 63a. Accordingly, the base member 63 can be moved in an optional direction relative to the lifting arm 159 and, accordingly, the lift pin 152 can be positioned to a desired position.

As shown in FIG. 12, the clamp member 64 has a pressing portion 64a for pressing the upper surface of the base member 63, an attaching portion 64b attached to the upper surface of the lifting arm 159 by the screw 65, and a connection portion 64c for connecting the pressing portion 64a and the attaching portion 64b. The pressing portion 64a and the attaching portion 64b are in parallel, and the connection portion 64c are vertical to them, that is, the clamp member 64 has a crank shape in a side elevation view. A recess 64d is formed in the pressing portion 64a so as not to interfere in the lift pin 52. Further, a lower surface of the pressing portion 64a on the side of the base end (on the side near the screw 65) is recessed so as to ensure that the pressing portion 64a presses only the portion from the center of the base member 63 to the side remote from the screw 65 on the upper surface of the base member 63, whereby a pressing surface 64e is formed at the pressing portion 64a at the lower surface on the side of the distal end.

After the position adjustment of the lift pin 152, by placing the pressing portion 64a at a predetermined position on the base member 63 and clamping the screw 65 to press the attaching portion 64b against the upper surface of the lifting arm 159, the pressing portion 64a presses the base member 63. Thus, the base member 63 is fixed to the lifting arm 159 and the lift pin 152 is positioned.

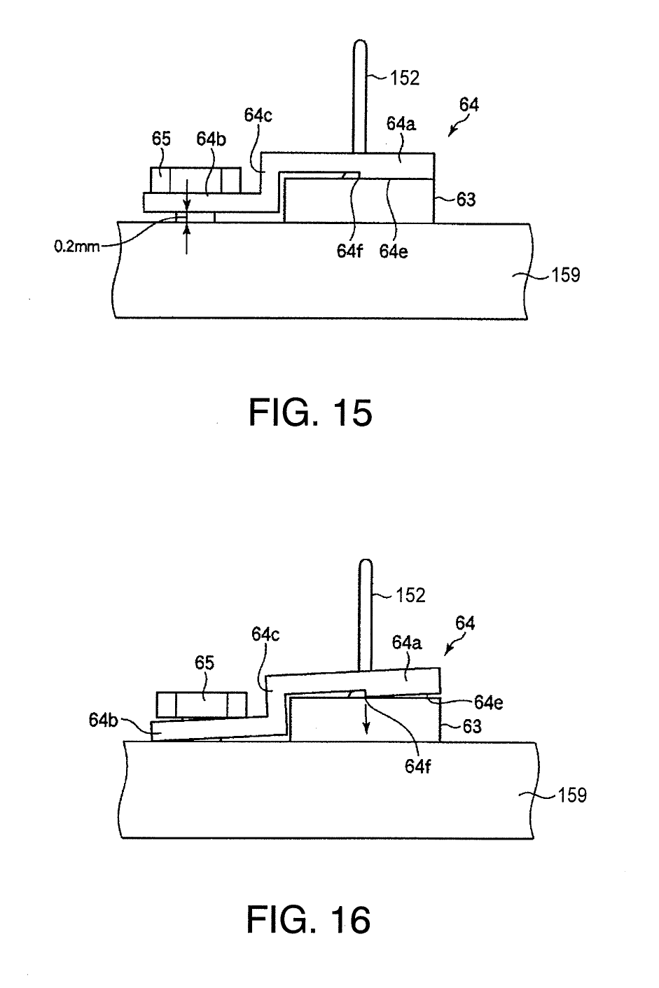

As shown in FIG. 15, the dimension of the clamp member 64 is determined such that a gap of about 0.2 mm is formed between the lower surface of the attaching portion 64b and the upper surface of the lifting arm 159 when the lower surface of the pressing portion 64a is in close contact with the upper surface of the base member 63. Thus, when the screw 65 is fastened, the pressing portion 64a in its tilted state presses the base member 63 and can press the base member 63 at a high pressing force. In this situation, since the pressing surface 64e of the pressing portion 64a is positioned within a range from the outer circumferential portion (outer circumferential portion on the side remote from the screw 65) to the central portion of the base member 63. Therefore, as shown in FIG. 16, when the pressing portion 64a in its tilted state presses the base member 63, an edge portion 64f of the pressing surface 64e presses the central portion of the base member 63. Accordingly, tilting of the base member 63 by the pressing force can be avoided. The pressing method by the pressing portion 64a is not restricted to that described above but it may press also at the surface, or the entire lower surface of the pressing portion 64a may be a pressing surface.

Then, the operation of the plasma processing apparatus 100A that has the wafer placing table 5A having thus been configured is to be described. First, the wafer W is loaded into the chamber 1 in a state being placed on a wafer arm of a wafer transfer mechanism (not shown). Then, the lift pins 152 of the wafer lifting mechanism (substrate lifting mechanism) 158 are elevated and the wafer W is transferred from the wafer arm onto the lift pin 152, the lift pins 152 are moved down to place the wafer W on a susceptor, that is, on the wafer placing table 5A. Then, in the same manner as in the first embodiment, a necessary processing gas is introduced from the gas supply device 16 by way of the gas introduction port 15a into the chamber 1.

Then, in the same manner as in the first embodiment, microwaves are introduced in the chamber 1 to convert the processing gas into plasma, and plasma processing is performed on the wafer W by the plasma. In this state, a high frequency bias is applied to the wafer placing table 5A.

After the completion of the plasma processing as described above, the lift pins 152 of the wafer lifting mechanism 158 are moved upward to raise the wafer W as the substrate. In this state, the wafer arm of the wafer transfer mechanism (not shown) is inserted below the wafer W to transfer the wafer W to the wafer arm, and the wafer W is delivered out of the chamber 1.

In the plasma processing described above, when the placing table body 151 is made of AlN, the particles containing Al are formed upon exposure of the placing table body 151 to the plasma and they are deposited on the wafer W to result in contamination. Particularly, when a high frequency bias is applied to the wafer placing table 5A as in this embodiment, a contamination level may possibly become higher due to the ion drawing effect. Therefore, generation of the particles is suppressed by covering the upper surface and the lateral side of the placing table body 151 with the first cover 154 made of quartz and covering the opening 154a and the large diameter hole portion 153a of the insertion hole 153 with the second cover 155 made of quartz.

As described previously in the section for the background art, when the lift pin 152 is screwed directly to the lifting arm 159, it results in drawbacks that the lifting pins 152 cannot be positionally adjusted individually and also that the lift pin 152 tends to be tilted. When appropriate positional relation between the lift pin 152 and the insertion hole 153 and a sufficient parallelism between the axial line of the lift pin 152 and the axial line of the insertion hole 153 are not obtained, particles may be generated by rubbing between the lift pin 152 and the inner surface of the insertion hole. Also, the lift pin 152 may move the first cover 154 or the second cover 155 upward. When a floating pin not requiring individual positional adjustment for the lift pins 152 is used, rubbing between the lift pin and the inner surface of the insertion hole occurs inevitably in view of the structure which also results in the problem of generating the particles.

On the contrary, in this embodiment, since the lift pin 152 is screwed to the base member 63 and the lower surface of the base member 63 is in face-to-face contact with the upper surface of the lifting arm 159 so that high verticality can be ensured for the axial line of the lift pin 152 to the bottom face of the base member 63 as described above, the verticality of the lift pin 152 can be maintained. Further, since the protrusion 63a of the base member 63 is loosely fitted to the concave portion 159a formed on the upper surface of the lifting arm 159, the position of the lift pin 152 can be adjusted by moving the base member 63 in an optional direction within the range for the size of the gap between the inner surface of the concave portion 159a and the outer circumference of the protrusion 63a. The position of each of the lift pins 152 can be adjusted individually and the lift pin can be secured at a desired position by pressing the base member 63 from above by the pressing portion 64a of the clamp member 64 in such a positionally-adjusted state. In this state, a high verticality can be ensured for each of the lift pins 152. Accordingly, the insertion hole 153 and the lift pin 152 can be aligned accurately and, further, the lift pin 152 is not tilted. Therefore, a possibility of causing disadvantages such as generation of particles by rubbing between the lift pin 152 and the inner surface of the insertion hole 153 or raising of the first cover 154 and the second cover 155 by the lift pin 152 can be decreased extremely.

Further, when the male screw 62b of the lift pin 152 is screwed to the female screw 63b of the base member 63, the bottom face of the female screw 63b of the base member 63 and the bottom face of the lift pin 152 are in close contact with each other. Therefore, verticality of the lift pin 152 to the bottom face of the female screw 63b can be ensured irrespective of a minute clearance inevitably present at the screw coupling portion between the male screw 152b and the female screw 63b. Further, since the bottom face of the base member 63 and the upper surface of the lifting arm 159 have a high planarity such that the faces are in close contact with each other, the lift pin 152 is not tilted.

Further, the dimension of the clamp member 64 is determined such that a gap of about 0.2 mm is formed between the lower surface of the attaching portion 64b and the upper surface of the lifting arm 159, when the lower surface of the pressing portion 64a is brought into close contact with the upper surface of the base member 63. Thus, when the screw 65 is fastened, the pressing portion 64a in its tilted state can presses the base member 63 and can press the base member 63 at a high pressing force, to thereby secure the lift pin surely. Further, since the edge portion 64f of the pressing surface 64e presses the central portion of the base member 63 when the pressing portion 64a presses the base member 63 in the tilted state, this can prevent the base member 63 from tilting by a localized pressing force upon securing the lift pin 152.

The structure of attaching the lift pin 152 to the lifting arm 159 according to the second embodiment described above can be applied not only to the plasma processing apparatus but also to other various kinds of substrate processing apparatus.

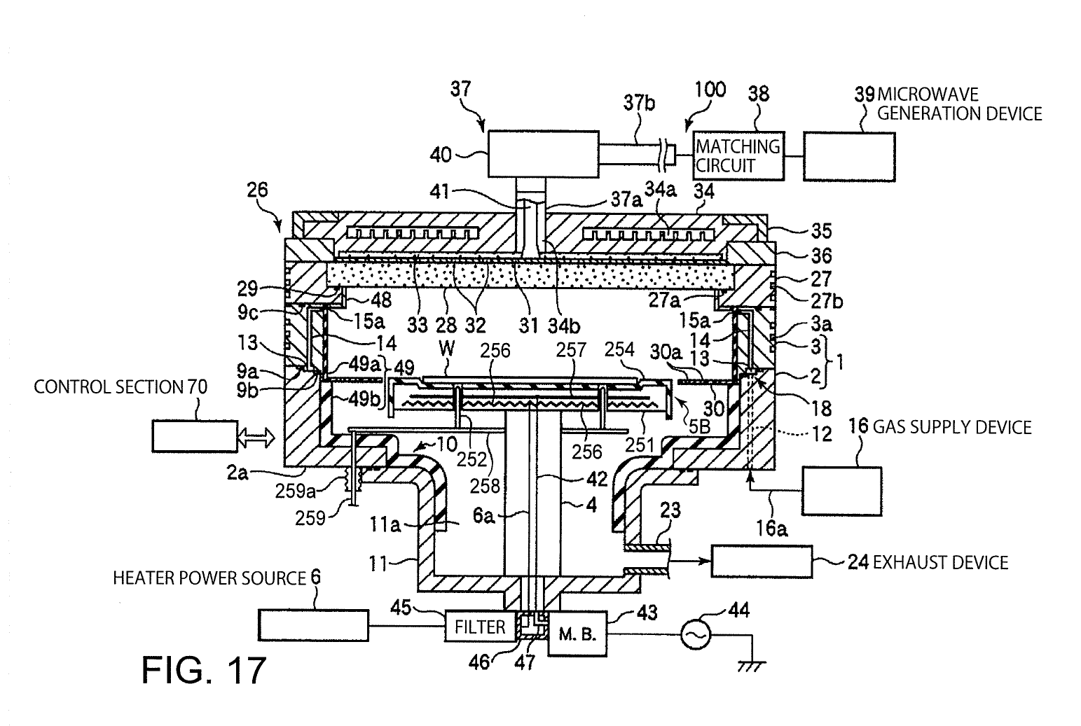

Then, a plasma processing apparatus 100B of the substrate processing apparatus according to a third embodiment of the invention is to be described. The third embodiment is different from the first embodiment mainly in the configuration of a cover disposed above the placing table body of the wafer placing table, and substantially identical with the first embodiment for other portions. In FIGS. 17 to 30 showing the third embodiment, identical portions with those of the first embodiment carry the same reference numerals for which duplicate description is to be omitted. While the plasma processing apparatus according to the third embodiment also has identical configurations to the plasma processing apparatus according to the first embodiment shown in FIGS. 2 to 4, duplicate description for them is also to be omitted. Further, the configuration of a heater 256, the configuration of an electrode 257, and power supply to the electrode 257 in the third embodiment are identical with the configuration of the heater 56, the configuration of the electrode 57, and power supply to the electrode 57 in the first embodiment respectively, and duplicate description for them is also to be omitted.

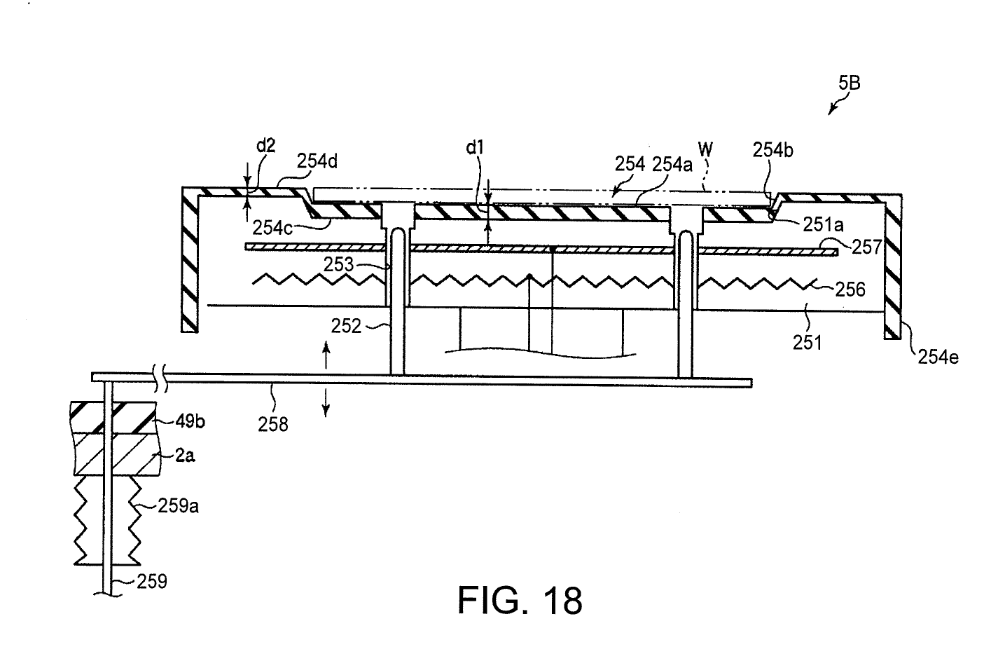

A wafer placing table 5B of the plasma processing apparatus 100B according to the third embodiment is to be described specifically. FIG. 18 is an enlarged cross sectional view of the wafer placing table 5B. As described above, the wafer placing table 5B is disposed in a housing 2 in a state supported by a cylindrical support member 4 extending upward from the central portion of the bottom of an exhaust chamber 11. A placing table body 251 of the wafer placing table 5B comprises AlN which is a ceramic material having good thermal conductivity. Three insertion holes 253 (only two of them are shown) through which lift pins 252 are inserted penetrate vertically inside the placing table body 251. A cover 254 is made of quartz at high purity and covers the upper surface and the lateral side of the placing table body 251.

A concave portion 251a to which the cover 254 is fitted is formed at a central portion of the upper surface of the placing table body 251 in a region corresponding to the region at which to place the wafer W. A convex portion 254c protruding downward so as to fit the concave portion 251a is formed at the central portion of the cover 254. A concave portion 254b is formed on the upper surface of the cover 54 on the side opposite to the convex portion 254c, and the bottom of the concave portion 254b forms a wafer placing region (substrate placing region) 254a for placing the wafer W thereon. Since the convex portion 254c of the cover 254 is fitted to the concave portion 251a, the cover 254 is not displaced from the placing table body 251.

The cover 254 is configured such that the thickness d1 of the central wafer placing region 254a is larger than the thickness d2 of the outer region 254d outside the wafer placing region 254a. Thus, it is configured such that the amount of heat per unit area supplied to the outer region 254d outside the wafer placing region 254a is larger than the amount of heat per unit area supplied from the placing table body 251 to the wafer placing region 254a. The temperature of the wafer W is controlled by adjusting the thickness d1 of the wafer placing region 254a and the thickness d2 of the outer region 254d.

The cover 254 has a lateral side 251e covering the lateral side of the placing table body 251, which prevents the placing table body 251 from contamination on the lateral side, for example, by sputtering.

A lift pin 252 inserted through an insertion hole 253 is secured to a pin support member 258. That is, the lift pin 252 is configured as a fixed pin. The pin support member 258 is connected with a lifting rod 259 extending in a vertical direction and the lift pin 252 is moved up and down by way of the pin support member 258 by moving the lifting rod 259 up and down by an actuator (not shown). A numeral 259a denotes bellows disposed such that the lifting rod 259 can be moved up and down in an airtight state.

The wafer placing table 5B is configured such that the wafer W is merely placed in the wafer placing region 254a at the central portion of the cover 254 described above.

Then, the operation of thus configured plasma processing apparatus 100B is to be described. First, the wafer W is loaded into the chamber 1 in a state being placed on a wafer arm (not shown) of a wafer transfer mechanism. Then, the lift pin 252 is moved upward, the wafer W is transferred from the wafer arm to the lift pins 252, and then the lift pins are moved down to place the wafer W over a susceptor 5. In the same manner as in the first embodiment, a necessary processing gas is then introduced from a gas supply device 16 by way of a gas introduction port 15a into the chamber 1.

Next, in the same manner as in the first embodiment, microwaves are introduced into the chamber 1 to convert the processing gas into plasma, and plasma processing is performed by the plasma on the wafer W heated by the heater 256.

During plasma processing described above, while heat (radiation heat) from the placing table body 251 heated by the heater 256 is supplied by way of the cover 254 to the wafer W, the temperature at the outer circumference of the wafer W has tended to be lowered so far. On the contrary, in this embodiment, since the thickness d1 of the wafer placing region 254a of the cover 254 is made larger than the thickness d2 of the outer region 254d outside the wafer placing region 254a, lowering of the temperature at the outer circumference of the wafer W can be suppressed by increasing the amount of heat per unit area supplied to the outer region 254d outside the placing surface 254 so as to be larger than the amount of heat per unit area supplied from the placing table body 251 to the placing surface 254a.

Conventionally, it was considered that the thickness of the cover 254 was uniform and the amount of heat per unit area given to the surface of the cover 254 was substantially uniform in a region where the heater 256 is present. Nevertheless, the temperature at the outer circumference of the wafer W tended to be lowered. This is supposed that since the outer circumference of the cover 254 is exposed to the processing space, heat is dissipated more in the outer circumference even when the amount of heat supplied is identical. Therefore, according to this embodiment, lowering of the temperature at the outer circumference of the wafer W is suppressed by supplying a more amount of heat to the outer region 254d than the wafer placing region 254a. That is, since the heat is transmitted by more amount to the upper surface of the cover 254 from the placing table body 251 below as the cover 254 is thinner, the amount of heat per unit area supplied to the upper surface of the outer region 254d having a relatively reduced thickness d2 is increased more than the amount of heat per unit area supplied to the upper surface of the wafer placing region 254a having a relatively increased thickness d1, thereby increasing the amount of heat supplied to the outer circumference of the wafer W. As a result, lowering of temperature is suppressed at the outer circumference of the wafer W. This can increase the plasma processing rate on the outer circumference of the wafer W to realize a uniform plasma processing. In this state, by making the difference larger between the thickness d1 and the thickness d2, the temperature at the outer circumference of the wafer W can be made relatively higher. Further, by properly adjusting the thickness d1 of the wafer placing region 254a and the thickness of the outer region d2 per se, the temperature of the wafer W per se can be controlled optically to perform uniform plasma processing.

That is, uniform plasma processing can be realized while utilizing the transmittance of the quartz cover 254 to thermal rays to relatively decrease the thickness for the outer region 254d of the cover 254 and to increase the amount of heat to the outer region 254d, thereby suppressing the lowering of the temperature at the outer circumference of the wafer W. In addition, uniform plasma processing is performed by optically controlling the temperature of the wafer W per se by changing the thickness of the cover 254 per se to adjust the amount of the thermal rays per se, reaching the wafer W.

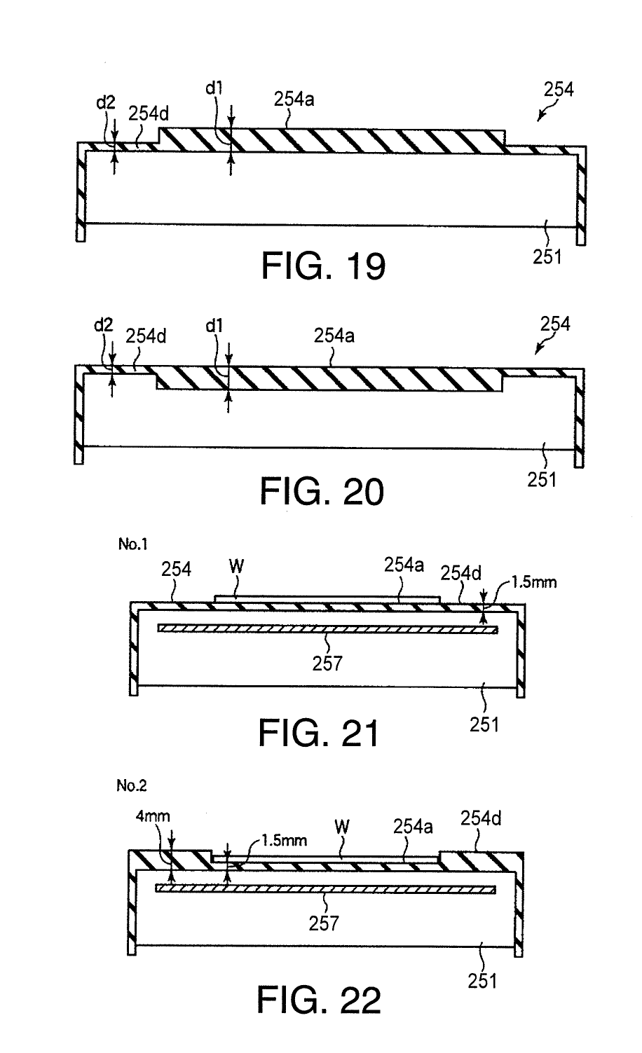

In the example described above, the concave portion 254c is formed on the cover 254 by forming the concave portion 251a to the placing table body 251 for positioning the wafer W and the placing surface 254a is formed therein. However, the upper surface of the placing table body 251 may be flat as shown in FIG. 19, or the upper surface of the cover 254 may be flat as shown in FIG. 20. In this case, the wafer W can be positioned by providing an outer wall or providing a plurality of guide pins outside the wafer W (both not shown).

Then, the result of simulation leading to the configuration of this embodiment is to be described. Temperatures at the center and the edge portion of a wafer when various shapes of covers are used are determined by simulation using a general purpose stationary heat conduction analysis software: 3GA (manufactured by Palsso Tech Co.) while considering only the thermal conduction without considering thermal radiation for the sake of simplicity.

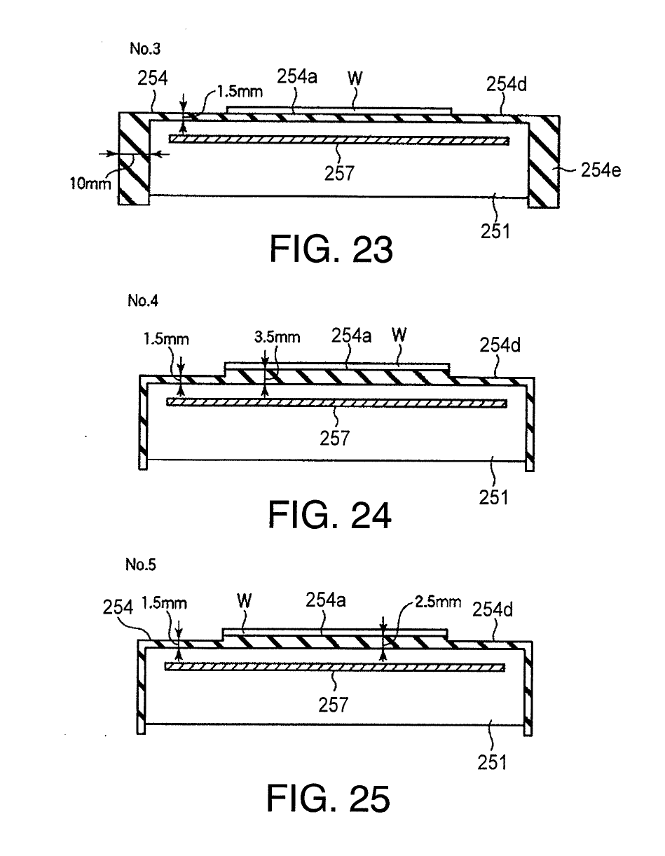

The thickness of the cover 254 was made uniform as 1.5 mm in No. 1 as a reference as shown in FIG. 21. Further, to increase the heat capacity of the outer region 254d more than that of the wafer placing region 254a of the cover 254, the thickness for the portion is increased as 4 mm in No. 2 as shown in FIG. 22. Further, to increase the thermal capacity more in the outer side of the wafer placing region 254a, the thickness of the lateral side 254e in contiguous with the outer region 254d was increased to 10 mm (11.5 mm in total) in No. 3 as shown in FIG. 23. In this case, a portion of a large thermal capacity is formed in the portion outside the wafer placing region 254a, intending to increase the temperature for the outer portion of the wafer W by accumulating heat in the portion.

As a result, in No. 1 as the reference, the central temperature TC of the wafer W placed in the wafer placing region 254a was 402.8° C., the edge temperature TE of the wafer W was 381.8° C., and the difference Δt therebetween was 21° C. In contrast, in No. 2, TC=398.1° C., TE=374.5° C., and Δt=23.6° C. In No. 3, TC=393° C., Te=368° C., and Δt=25° C. They provide a result that the temperature at the outer circumference of the wafer W is decreased significantly. This is considered to be attributable to that when the thickness is increased for the outer region 254d and the lateral side 254e, they function as a heat sink and the supply of heat to the outer region 254d was rather decreased than that for the wafer placing region 254a.

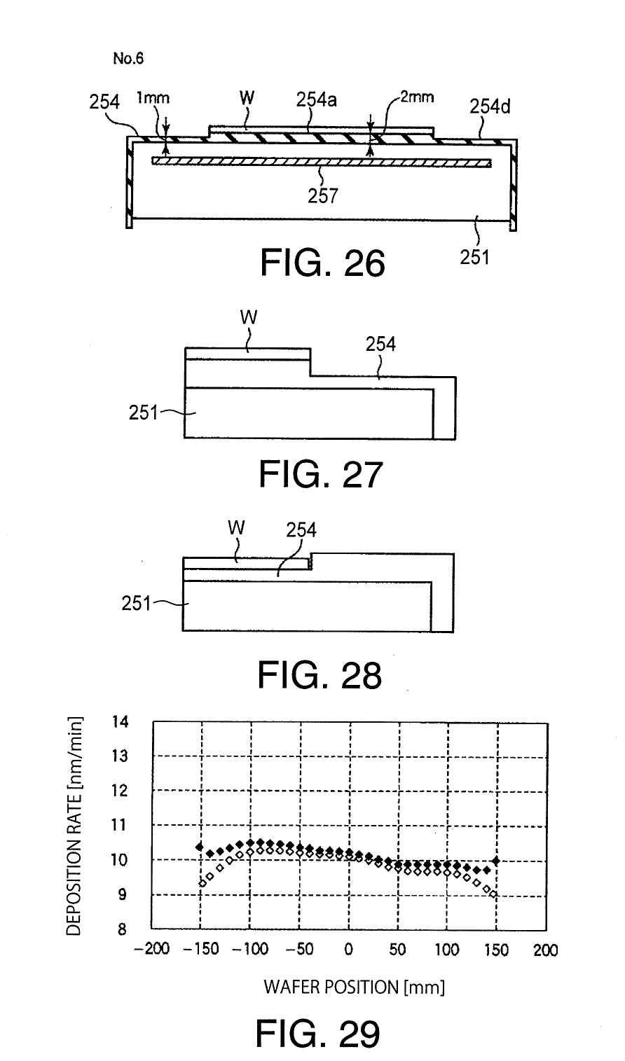

Then, simulation was performed for Nos. 4 and 5 where the thickness was increased conversely for the wafer placing region 254a of the cover 54. In No. 4, the thickness d1 of the wafer placing region 254a was increased to 3.5 mm, while the thickness d2 of the outer region 254d is kept at 1.5 mm as it was as shown in FIG. 24. In No. 5, d1 was increased to 2.5 mm and d2 was kept at 1.5 mm as it was as shown in FIG. 25. As a result, in No. 4, TC=346.6° C., TE=334.3° C. and Δt=12.3° C. In No. 5, TC=372.16° C., TE=357.7° C., and Δt=14.4° C., and Δt could be lowered. However, the result showed that TC was low as 346.6° C. in No. 4, and TC was still low as 372.16° C. though d1 was decreased to 2.5 mm in No. 5. Then, simulation was performed for the sample of d1 at 2 mm and d2 at 1 mm as shown in FIG. 26 as No. 6 and, as a result, TC could be within an allowable range as: TC=386.7° C., TE=373.7° C., and Δt=13° C. Further, the temperature can be controlled more strictly by further adjusting the thickness of the cover 254. However, it is considered that there is a limit due to the problem in fabrication, etc.

As described above, when the thickness d2 for the outer region 254d is decreased by a predetermined amount than the thickness d1 for the wafer placing region 254a of the cover 254, lowering of the temperature for the wafer edge portion can be suppressed. Then, it was confirmed that more uniform plasma processing can be performed by properly adjusting the thickness for the wafer placing region 254a and the thickness for the outer region 254d to properly control the temperature of the wafer W while suppressing the lowering of the temperature for the outer circumference of the wafer W.

Then, the result of actually performing the plasma processing by using the wafer placing table according to this embodiment is to be described in comparison with the comparative example. In this case, silicon nitride films were deposited in the plasma processing apparatus shown in FIG. 17 by using a wafer placing table according to this embodiment shown in FIG. 27 and a wafer placing table according to the comparative example shown in FIG. 28. The deposition treatment was performed in this case under the condition of a pressure in the chamber at 6.7 Pa, the power of the high frequency bias at 3 kW, supplying N₂ gas at 600 mL/min (sccm), an Ar gas at 100 mL/min (sccm), and an Si₂H₆ gas at 4 mL/min (sccm) in the flow rate, and the temperature for the placing table body set at 500° C. FIG. 29 shows a relation between the position on the wafer and the film deposition rate in this case. As shown in the graph, while the deposition rate was lowered at the edge of the wafer in the case of the comparative example, it was confirmed that the lowering of the deposition rate at the wafer edge was suppressed when the wafer placing table according to this embodiment was used. In this case, it was confirmed that the uniformity of the deposition rate (1σ) was 5.5% in the comparative example, whereas it was 3.3% in this embodiment and the uniformity of the deposition rate (plasma processing) was higher in this embodiment.

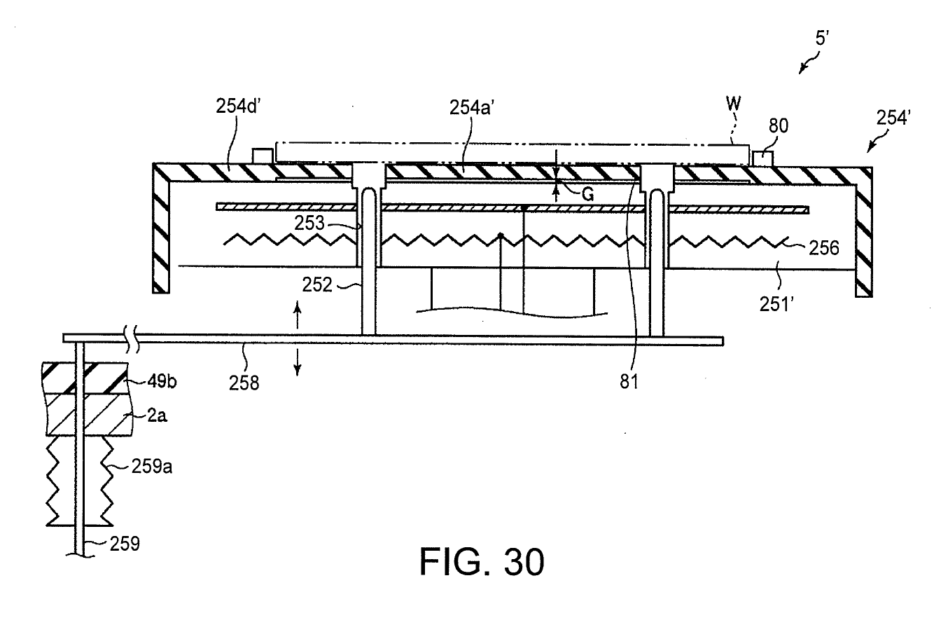

Then, a modified example of the third embodiment is to be described. FIG. 30 is an enlarged cross sectional view of a wafer placing table 5′ that is used in the plasma processing apparatus according to the modified example. Since the basic structure of the wafer placing table 5′ is identical with that of the wafer placing table 5B shown in FIG. 18, identical portions carry the same reference numerals for which description is to be omitted. The wafer placing table 5′ of this embodiment has a placing table body 251′ made of AlN and having a planar upper surface, and a cover 254′ made of quartz at high purity and disposed so as to cover the surface of the placing table body 251′.

The cover 254′ has a wafer placing region 254a′ at a central portion of the upper surface thereof. The upper surface of the cover 254′ is planar and a plurality of guide pins 80 are disposed thereon for positioning the wafer W to the wafer placing region 254a′.

A step is formed between the wafer placing region 254a′ and the outer region 254d′ present outside thereof at the lower surface of the cover 254′, and a gap 81 is formed between the lower surface of the wafer placing region 254a′ of the cover 254′ and the upper surface of the placing table body 251′ due to the step. In contrast, the lower surface of the outer region 254d′ of the cover 254′ is in contact with the upper surface of the placing table body 251′ and a gap is not formed between them. That is, the distance between the lower surface of the outer region 254d′ and the upper surface of the placing table body 251′ is 0, which is smaller than the distance between the lower surface of the wafer placing region 254a′ and the upper surface of the placing table body 251′. Accordingly, heat is transmitted directly from the placing table body 251′ to the outer region 254d′ in which the gap is not present. However, since heat is transmitted from the placing table body 251′ to the wafer placing region 254a′ by way of the gap 81, the amount of the transmitted heat is decreased naturally. Accordingly, the amount of heat per unit area supplied to the outer region 254d′ is increased more than the amount of heat per unit area supplied to the wafer placing region 254a′ from the placing table body 251′. Therefore, the amount of heat supplied to the outer circumference of the wafer W is increased also in this modified embodiment and, as a result, lowering of the temperature for the outer circumference of the wafer W can be suppressed to perform uniform plasma processing. In this case, the temperature of the wafer W per se can be controlled by properly adjusting the distance G of the gap 81, and the temperature of the wafer W per se can also be controlled in addition to suppression of lowering of the temperature for the outer circumference of the wafer W, and thereby the plasma processing rate can be controlled.

However, when the distance G of the gap 81 is excessively large, there may be a possibility that the temperature of the wafer W cannot be controlled to a desired temperature. Accordingly, in a case where the temperature of the wafer W cannot be controlled sufficiently even when the distance G of the gap 81 is increased to an allowable range, the heat ray transmittance can be controlled by providing the gap 71 between the wafer placing region 254a′ and the placing table body 251′ and, further, by adjusting the thickness d1 and d2 per se, for example, by decreasing the thickness d2 of the outer region 254d′ less than the thickness d1 of the wafer placing region 254a′ as in the embodiment described previously. This can increase the temperature adjusting margin further and the temperature can be controlled such that uniform plasma processing can be performed and, in addition, desired plasma processing rate can be obtained. The temperature adjusting margin can be increased more also by providing a gap between the outer region 254d′ and the placing table body 251′ and adjusting the gap and the gap 81 described above. That is, the temperature may also be adjusted by adjusting the distance between the lower surface of the wafer placing region 254a′ and the outer region 254d′ of the cover 254′, and the upper surface of the placing table body 251′.

The present invention is not restricted to the embodiments described above, but can be modified variously. For example, while the apparatus for applying a high frequency bias to the wafer placing table is illustrated in the embodiments described above, it may be also an apparatus not applying the high frequency bias. Further, while the RLSA system plasma processing apparatus has been exemplified as the plasma processing apparatus in the embodiments described above, it may be also plasma processing apparatus of other systems, for example, remote plasma system, ICP system, ECR system, surface reflection wave system, and magnetron system. Also the content of the plasma processing is not particularly restricted but may be directed to various plasma processing such as plasma oxidation processing, plasma nitridation processing, plasma oxynitridation processing, plasma deposition processing, and plasma etching. Further, the substrate is not restricted to the semiconductor wafer but may also be other substrates such as glass substrate for FPD, etc.

Various characteristic configurations shown in the first to third embodiments described above can be combined optionally. For example, the substrate lifting mechanism shown in the second embodiment may be used in combination with various forms of the first cover and the second cover.

Further, means for adjusting the temperature relation between the substrate placing region and the outer region (specifically, the thickness of the cover is made different between the substrate placing region and the outer region, or a gap is formed between the cover and the placing table body in the substrate placing region) shown in the third embodiment can be combined with the configurations shown in the first embodiment and the second embodiment. In this case, it may suffice to configure such that at least one of the following dimensional relations is established, i.e., (i) the thickness for the first cover in the substrate placing region is larger than the thickness for the first cover in the outer region outside the substrate placing region, and (ii) the distance between the lower surface of the first cover and the upper surface of the substrate placing table body in the substrate placing region is smaller than the distance between the lower surface of the cover and the upper surface of the substrate placing table body in the outer region outside the substrate placing region.

1. A substrate processing apparatus comprising:
a processing container, for accommodating a substrate, which is capable of maintaining a vacuum therein;
a substrate placing table for placing the substrate thereon in the processing container;
a processing gas supply mechanism for supplying a processing gas into the processing container; and
a plasma generation mechanism for generating a plasma of the processing gas in the processing container,
wherein the substrate placing table includes:
a substrate placing table body composed of AlN;
a heat generation member disposed in the substrate placing table body to heat the substrate placed thereon;
a first cover, made of quartz, covering a surface of the substrate placing table body;
a plurality of lift pins provided so as to be projectable and retractable relative to an upper surface of the substrate placing table to move the substrate up and down;
a plurality of insertion holes formed in the substrate placing table body to allow the lift pins to be inserted through;
a plurality of openings formed in the first cover, located at positions corresponding to the plurality of insertion holes, respectively; and
a plurality of second covers made of quartz, disposed at the insertion holes, respectively, and formed separately from the first cover,
wherein each of the second covers at least a portion of an inner circumferential surface of the insertion hole corresponding to the second cover and at least a portion of an inner surface of the opening corresponding to the second cover, such that a surface, near an upper end of the corresponding to the insertion hole, of the substrate placing table body composed of AlN is not exposed to a plasma generated in the processing container.

2. The substrate processing apparatus according to claim 1, wherein:
each of the second covers has a cylindrical portion covering at least an upper portion of the inner circumferential surface of each of the insertion holes and a flanged portion extending outward from the upper end of the cylindrical portion; and
the flanged portion is disposed in the opening.

3. The substrate processing apparatus according to claim 2, wherein each of the insertion holes has, in an upper portion thereof, a large diameter hole portion of a larger diameter, and the cylindrical portion is fitted into the large diameter hole portion.

4. The substrate processing apparatus according to claim 2, wherein the cylindrical portion covers the entire inner circumferential surface of the insertion hole.

5. The substrate processing apparatus according to claim 2, wherein:
a step is formed in the inner surface of each of the openings, whereby the opening has an upper small diameter portion and a lower large diameter portion and an eave protruding above the large diameter portion of the opening is disposed in the first cover; and
the flanged portion of the second cover enters the large diameter portion of the opening below the eave.

6. The substrate processing apparatus according to claim 2, wherein:
a step is formed in the inner surface of each of the openings, whereby the opening has an upper large diameter portion and a lower small diameter portion; and
the flanged portion of the second cover is inserted into the large diameter portion of the opening.

7. The substrate processing apparatus according to claim 1, wherein the plasma generation mechanism has a plane antenna having a plurality of slots and microwave introduction means for introducing microwaves via the plane antenna into the processing container, and the processing gas is converted into a plasma by the introduced microwaves.

8. The substrate processing apparatus according to claim 7, further comprising a high frequency bias application unit that applies a high frequency bias for drawing ions in the plasma to the substrate placing table.

9. The substrate processing apparatus according to claim 1, wherein the substrate placing table includes:
a lifting arm that supports the lift pins,
an actuator that moves the lift pins up and down via the lifting arm, and
a lift pin attaching portion for attaching the lift pins to the lifting arm,
wherein the lift pin attaching portion includes a concave portion provided in an upper surface of the lifting arm at a position corresponding to the lift pin, a base member to which the lift pin is screw fastened, and a clamp member for securing the base member to the lifting arm by clamping the base member, and
wherein the base member has a protrusion protruding downward from a bottom face of the base member and loosely fitted into the concave portion.

10. The substrate processing apparatus according to claim 1, wherein:
the first cover has a placing region for placing the substrate thereon, and
the placing table body and the first cover are configured such that at least one of the following dimensional relationships is established:
(i) a thickness of the first cover in the substrate placing region is larger than a thickness of the first cover in an outer region outside the substrate placing region, and
(ii) a distance between a lower surface of the first cover and an upper surface of the substrate placing table body in the substrate placing region is larger than the distance between the lower surface of the first cover and the upper surface of the substrate placing table body in the outer region outside the substrate placing region.

11. A substrate placing table for placing a substrate thereon in a processing container in a substrate processing apparatus for performing plasma processing to the substrate in the processing container held in vacuum, the substrate placing table comprising:
a substrate placing table body composed of AlN;
a heat generation member disposed in the substrate placing table body to heat the substrate placed thereon;
a first cover, made of quartz, covering a surface of the substrate placing table body;
a plurality of lift pins provided so as to be projectable and retractable relative to an upper surface of the substrate placing table to move the substrate up and down;
a plurality of insertion holes formed in the substrate placing table body to allow the lift pins to be inserted through;
a plurality of openings formed in the first cover, located at positions corresponding to the plurality of insertion holes, respectively; and
a plurality of second covers made of quartz, disposed at the insertion holes, respectively, and formed separately from the first cover,
wherein each of the second covers covers at least a portion of an inner circumferential surface of the insertion hole corresponding to the second cover and at least a portion of an inner surface of the opening corresponding to the second cover, such that a surface, near an upper end of the corresponding to the insertion hole, of the substrate placing table body composed of AlN is not exposed to a plasma generated in the processing container.

12. The substrate placing table according to claim 11, wherein:
each of the second covers has a cylindrical portion covering at least an upper portion of the inner circumferential surface of each of the insertion holes and a flanged portion extending outward from the upper end of the cylindrical portion; and
the flanged portion is disposed in the opening.

13. The substrate placing table according to claim 12, wherein each of the insertion holes has, in an upper portion thereof, a large diameter hole portion of a larger diameter, and the cylindrical portion is fitted into the large diameter hole portion.

14. The substrate placing table according to claim 12, wherein the cylindrical portion covers the entire inner circumferential surface of the insertion hole.

15. The substrate placing table according to claim 12, wherein:
a step is formed in the inner surface of each of the openings, whereby the opening has an upper small diameter portion and a lower large diameter portion and an eave protruding above the large diameter portion of the opening is disposed in the first cover; and
the flanged portion of the second cover enters the large diameter portion of the opening below the eave.

16. The substrate placing table according to claim 12, wherein:
a step is formed in the inner surface of each of the openings, whereby the opening has an upper large diameter portion and a lower small diameter portion; and
the flanged portion of the second cover is inserted into the large diameter portion of the opening.

17. The substrate placing table according to claim 11, further including:
a lifting arm that supports the lift pins;
an actuator that moves the lift pins up and down via the lifting arm; and
a lift pin attaching portion for attaching the lift pins to the lifting arm,
wherein the lift pin attaching portion includes a concave portion provided in an upper surface of the lifting arm at a position corresponding to the lift pin, a base member to which the lift pin is screw fastened, and a clamp member for securing the base member to the lifting arm by clamping the base member, and
wherein the base member has a protrusion protruding downward from a bottom face of the base member and loosely fitted into the concave portion.

18. The substrate placing table according to claim 11, wherein:
the first cover has a substrate placing region for placing the substrate thereon; and
the placing table body and the first cover are configured such that at least one of the following dimensional relationships is established:
(i) a thickness of the first cover in the substrate placing region is larger than a thickness of the first cover in an outer region outside the substrate placing region, and
(ii) a distance between a lower surface of the first cover and an upper surface of the substrate placing table body in the substrate placing region is smaller larger than the distance between the lower surface of the cover and the upper surface of the substrate placing table body in the outer region outside the substrate placing region.

19. A substrate processing apparatus comprising:
a processing container, for accommodating a substrate, which is capable of maintaining a vacuum therein;
a substrate placing table for placing the substrate thereon in the processing container;
a processing gas supply mechanism for supplying a processing gas into the processing container; and
a plasma generation mechanism for generating a plasma of the processing gas in the processing container,
wherein the substrate placing table includes:
a substrate placing table body;
a heat generation member disposed in the substrate placing table body to heat the substrate placed thereon;
a first cover, made of quartz, covering a surface of the substrate placing table body;
a plurality of lift pins provided so as to be projectable and retractable relative to an upper surface of the substrate placing table to move the substrate up and down;
a plurality of insertion holes formed in the substrate placing table body to allow the lift pins to be inserted through;
a plurality of openings formed in the first cover, located at positions corresponding to the plurality of insertion holes, respectively; and
a plurality of second covers made of quartz, disposed at the insertion holes, respectively, and formed separately from the first cover,
wherein each of the second covers at least a portion of an inner circumferential surface of the insertion hole corresponding to the second cover and at least a portion of an inner surface of the opening corresponding to the second cover, such that a surface, near an upper end of the corresponding to the insertion hole, of the substrate placing table body is not exposed to a plasma generated in the processing container.

20. The substrate processing apparatus according to claim 1, wherein:
each of the second covers has a cylindrical portion covering at least an upper portion of the inner circumferential surface of each of the insertion holes and a flanged portion extending outward from the upper end of the cylindrical portion; and
the flanged portion is disposed in the opening.
